(19) United States
(12) Patent Application Publication
(10) Pub. No.: US 2026/0227881 A1
(43) Pub. Date: Aug. 6, 2026

(54) PERFORMING OPERATIONS BASED ON A PRESENCE OF A SET OF COLLOCATED USERS OF ELECTRONIC DEVICES

(71) Applicant: Apple Inc., Cupertino, CA (US)

(72) Inventors: Patrick PIEMONTE, San Francisco, CA (US); Joseph P. CERRA, San Francisco, CA (US); Tommy ROCHETTE, Santa Cruz, CA (US)

(21) Appl. No.: 19/453,964

(22) Filed: Jan. 20, 2026

Related U.S. Application Data
(60) Provisional application No. 63/753,398, filed on Feb. 3, 2025.

(51) Int. Cl. G06F 3/04815

(52) U.S. Cl. CPC G06F 3/04815

(57) ABSTRACT

An electronic device may perform one or more operations based on a presence of users that are collocated in a physical environment. In some examples, were a first electronic device to detect that it is collocated with a first set of users in the physical environment, the first electronic device would perform one or more operations contextualized to the first set of users. In some examples, were the first electronic device to detect that it is collocated with a second set of users in the physical environment that is different from the first set of users, the first electronic device would perform one or more operations contextualized to the second set of users. In some examples, were no set of users collocated with the first user in the physical environment, the first electronic device would perform one or more default operations.

### CROSS-REFERENCE TO RELATED APPLICATIONS

This application claims the benefit of U.S. Patent Application No. 63/753,398, filed Feb. 3, 2025, the content of which is incorporated herein by reference in its entirety.

### FIELD OF THE DISCLOSURE

This relates generally to performing operations based on a presence of a set of users of electronic devices that are collocated in a physical environment.

### BACKGROUND OF THE DISCLOSURE

Some computer graphical environments provide two-dimensional and/or three-dimensional environments where at least some objects displayed for a user's viewing are virtual and generated by a computer.

### SUMMARY OF THE DISCLOSURE

An electronic device may perform one or more operations based on a presence of a set of users of electronic devices that is collocated in a physical environment. In some examples, were a first electronic device associated with a first user to detect that it is collocated with a first set of users in the physical environment, the first electronic device would perform one or more operations contextualized to the first set of users. In some examples, were the first electronic device to detect that it is collocated with a second set of users in the physical environment that is different from the first set of users, the first electronic device would perform one or more operations contextualized to the second set of users. In some examples, were no set of users collocated with the first user in the physical environment, the first electronic device would perform one or more default operations. In some examples, the one or more operations contextualized to the first set of users includes display of data and/or user interfaces that were previously shared or used between the first user of the first electronic device and the first set of users. In some examples, the one or more operations contextualized to the second set of users includes display of data and/or user interfaces that were previously shared or used between the first user of the first electronic device and the second set of users. In some examples, the one or more operations are performed relative to a first application. For example, were a first electronic device to detect that it is collocated with the first set of users in the physical environment, the first electronic device would perform one or more operations contextualized to the first set of users relative to the first application, and were the first electronic device to detect that it is collocated with the second set of users in the physical environment, the first electronic device would perform one or more operations contextualized to the second set of users relative to the first application. As such, in some examples, the first electronic device can cause an application to behave differently based on the set of users in the physical environment that are collocated with the first user.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter. Further, it is understood that the Summary of the Disclosure does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A through 2C illustrate a block diagram of an example architecture for a system according to some examples of the disclosure.

FIGS. 3 through 8B generally illustrate a first electronic device associated with a first user detecting and responding to being collocated in a physical environment with a second user of a second electronic device according to some examples of the disclosure.

FIGS. 9 through 14 generally illustrate the first electronic device associated with the first user detecting and responding to being collocated in the physical environment with a third user of a third electronic device according to some examples of the disclosure.

FIGS. 15 through 20 generally illustrate the first electronic device associated with the first user detecting and responding to being collocated in the physical environment with the second user of the second electronic device and the third user of the third electronic device according to some examples of the disclosure.

FIGS. 20 through 30 generally illustrate the first electronic device causing an application to perform different operations based on who is collocated in the physical environment with the first user according to some examples of the disclosure.

FIGS. 31 and 32 generally illustrate an example of the first electronic device visually emphasizing the set of users of electronic devices with whom the first user of the first electronic device is collocated in the physical environment according to some examples of the disclosure.

FIGS. 33 through 37 generally illustrate another example of the first electronic device detecting and responding to being collocated in the physical environment with another user of another electronic device according to some examples of the disclosure.

FIGS. 38 through 40 generally illustrate another example of the first electronic device detecting and responding to being collocated in the physical environment with a set of users of electronic devices according to some examples of the disclosure.

FIG. 41 illustrates a flow diagram illustrating a method for performing one or more operations contextualized to a set of users of electronic devices that are collocated in a physical environment according to some examples of the disclosure.

FIG. 42 illustrates an example of a spatial group in a multi-user communication session that includes a plurality of electronic devices according to some examples of the disclosure.

### DETAILED DESCRIPTION

An electronic device may perform one or more operations based on a presence of a set of users of electronic devices that is collocated in a physical environment. In some examples, were a first electronic device associated with a first user to detect that it is collocated with a first set of users in the physical environment, the first electronic device would perform one or more operations contextualized to the first set of users. In some examples, were the first electronic device to detect that it is collocated with a second set of users in the physical environment that is different from the first set of users, the first electronic device would perform one or more operations contextualized to the second set of users. In some examples, were no set of users collocated with the first user in the physical environment, the first electronic device would perform one or more default operations. In some examples, the one or more operations contextualized to the first set of users includes display of data and/or user interfaces that were previously shared or used between the first user of the first electronic device and the first set of users. In some examples, the one or more operations contextualized to the second set of users includes display of data and/or user interfaces that were previously shared or used between the first user of the first electronic device and the second set of users. In some examples, the one or more operations are performed relative to a first application. For example, were a first electronic device to detect that it is collocated with the first set of users in the physical environment, the first electronic device would perform one or more operations contextualized to the first set of users relative to the first application, and were the first electronic device to detect that it is collocated with the second set of users in the physical environment, the first electronic device would perform one or more operations contextualized to the second set of users relative to the first application. As such, in some examples, the first electronic device can cause an application to behave differently based on the set of users in the physical environment that are collocated with the first user.

It is understood that references herein to “collocate” and/or “collocated” optionally refer to entities that are co-located sharing a physical space, and that such references optionally differ from the conventional meaning of collocate (e.g., is optionally different from placing objects side by side with a particular spatial relation). Additionally, references herein to any neologisms such as “collocate” and/or “collocated” are understood to similarly refer to entities that are co-located and share a physical space. Further, note that when a first electronic device is collocated in a physical environment with a second electronic device, the user of the first electronic device and the user of the second electronic device are likewise determined to be collocated (e.g., detected as being collocated in the physical environment). Furthermore, the term “and/or” as used herein refers to and encompasses any and all possible combinations of one or more of the associated listed items (e.g., “A and/or B” refers to “A and B” and, optionally, “A or B”).

In some examples, a spatial group or state in the multi-user communication session denotes a spatial arrangement or template that dictates locations of users and content that are located in or otherwise associated with the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

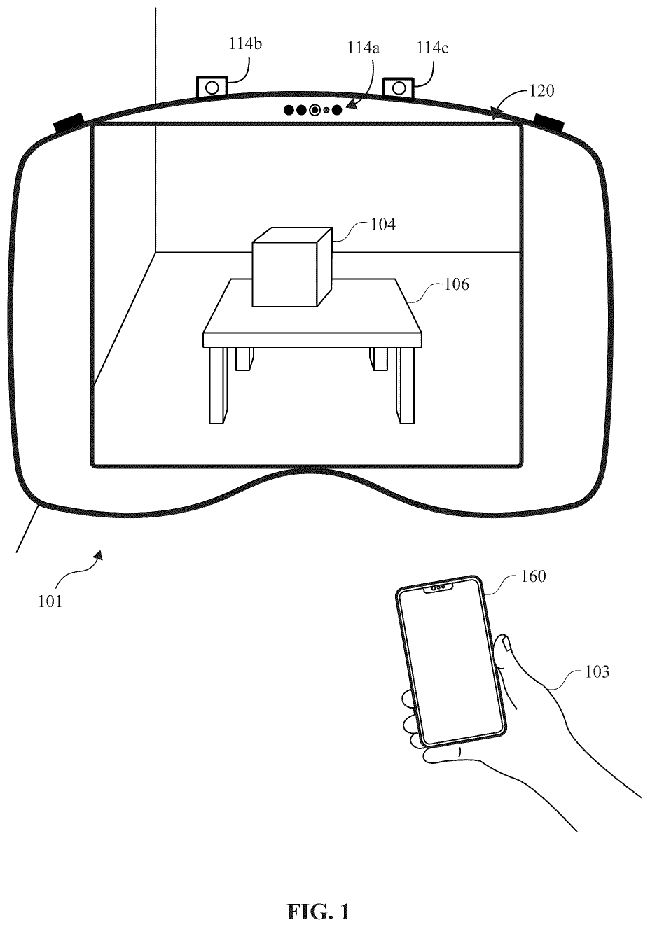

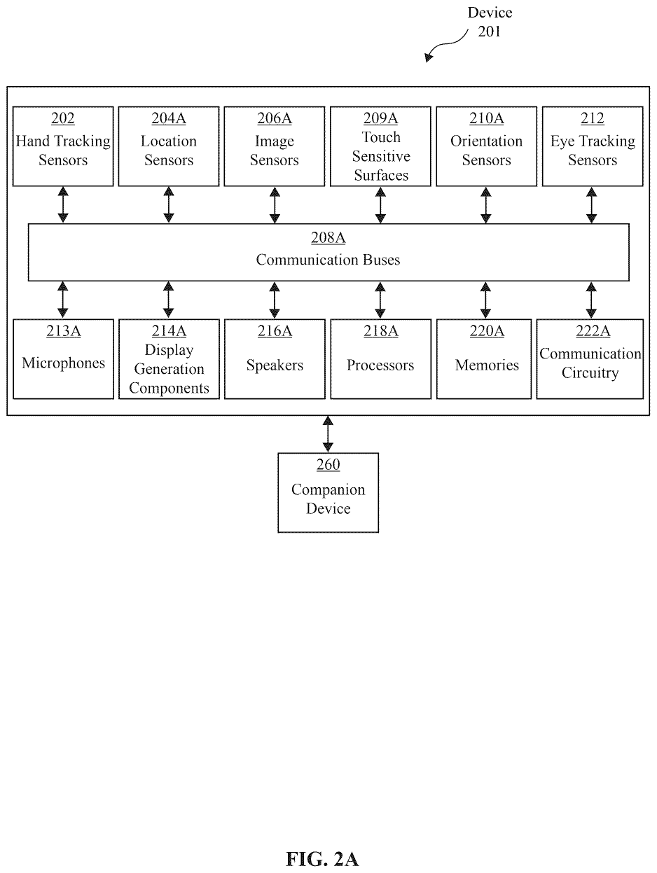

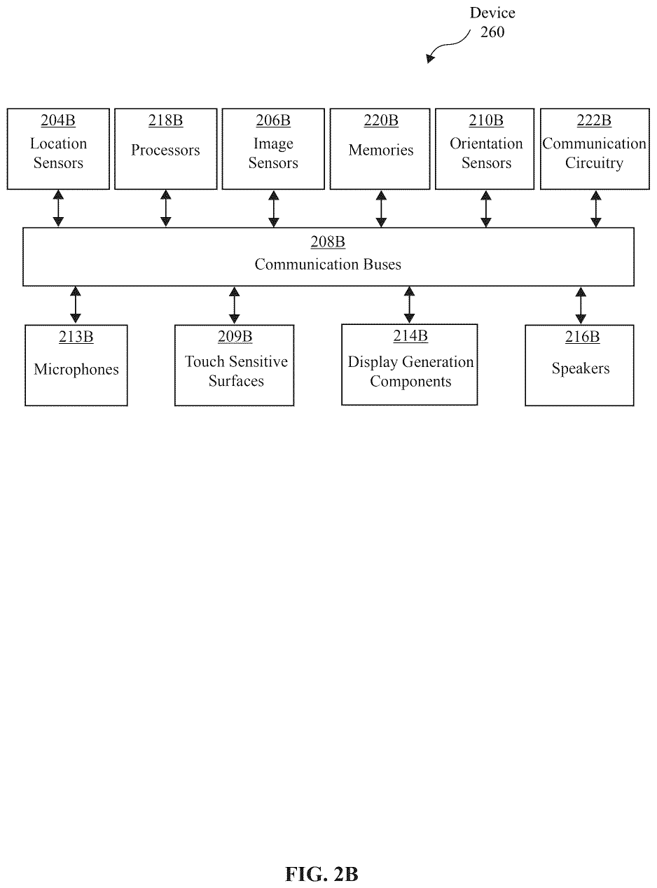

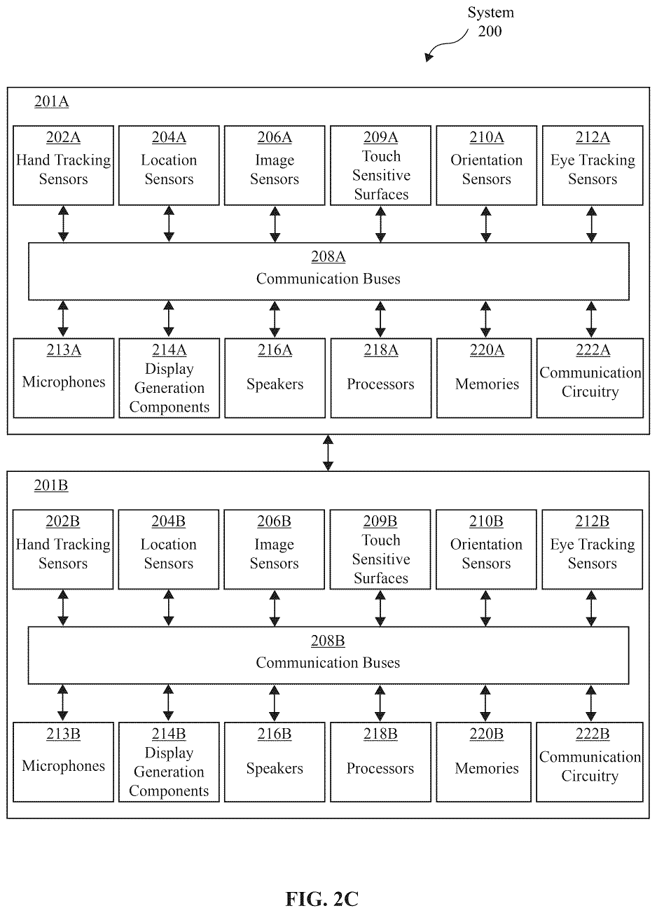

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2C.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2C illustrate block diagrams of example architectures for electronic devices or systems according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

FIG. 2C illustrates a block diagram of an example architecture for a system 200 according to some examples of the disclosure. In some examples, system 200 includes multiple electronic devices. For example, in FIG. 2C, the system 200 includes a first electronic device 201A and a second electronic device 201B, wherein the first electronic device 201A and the second electronic device 201B are in communication with each other. In some examples, the first electronic device 201A and the second electronic device 201B correspond to and/or have one or more characteristics of the electronic device 201 described above with reference to FIG. 2A. In some examples, the first electronic device 201A and the second electronic device 201B correspond to electronic device 101 described above with reference to FIG. 1. For example, as shown in FIG. 2C, the first electronic device 201A optionally includes various sensors (e.g., the one or more hand tracking sensors 202A, the one or more location sensors 204A, the one or more image sensors 206A, the one or more touch-sensitive surfaces 209A, the one or more motion and/or orientation sensors 210A, the one or more eye tracking sensors 212A, the one or more microphones 213A or other audio sensors, the one or more body tracking sensors (e.g., torso and/or head tracking sensors), the one or more display generation components 214A, the one or more speakers 216A, the one or more processors 218A, the one or more memories 220A, and/or the communication circuitry 222A described above with reference to FIGS. 2A-2B. Similarly, in some examples, the second electronic device 201B optionally includes various sensors (e.g., one or more hand tracking sensors 202B, the one or more location sensors 204B, the one or more image sensors 206B, the one or more touch-sensitive surfaces 209B, the one or more motion and/or orientation sensors 210B, one or more eye tracking sensors 212B, the one or more microphones 213B or other audio sensors, one or more body tracking sensors (e.g., torso and/or head tracking sensors), the one or more display generation components 214B, one or more speakers 216B, the one or more processors 218B, the one or more memories 220B, and/or the communication circuitry 222B described above with reference to FIGS. 2A-2B. In some examples, the one or more hand tracking sensors 202B have one or more characteristics of the one or more hand tracking sensors 202A discussed above. In some examples, the one or more eye tracking sensors 212B have one or more characteristics of the one or more eye tracking sensors 212A. One or more communication buses 208A and 208B are optionally used for communication between the above-mentioned components of first electronic device 201A and second electronic device 201B, respectively. First electronic device 201A and second electronic device 201B optionally communicate via a wired or wireless connection (e.g., via the communication circuitry 222A, 222B) between the two electronic devices.

System 200 is not limited to the components and configuration of FIG. 2C, but can include fewer, other, or additional components and/or electronic devices in multiple configurations. In some examples, system 200 can be implemented in a single device. A person or persons using system 200, is optionally referred to herein as a user or users of the system and/or the devices or devices.

Attention is now directed towards exemplary concurrent displays of a three-dimensional environment on a first electronic device (e.g., corresponding to electronic device 201A) and a second electronic device (e.g., corresponding to electronic device 201B). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

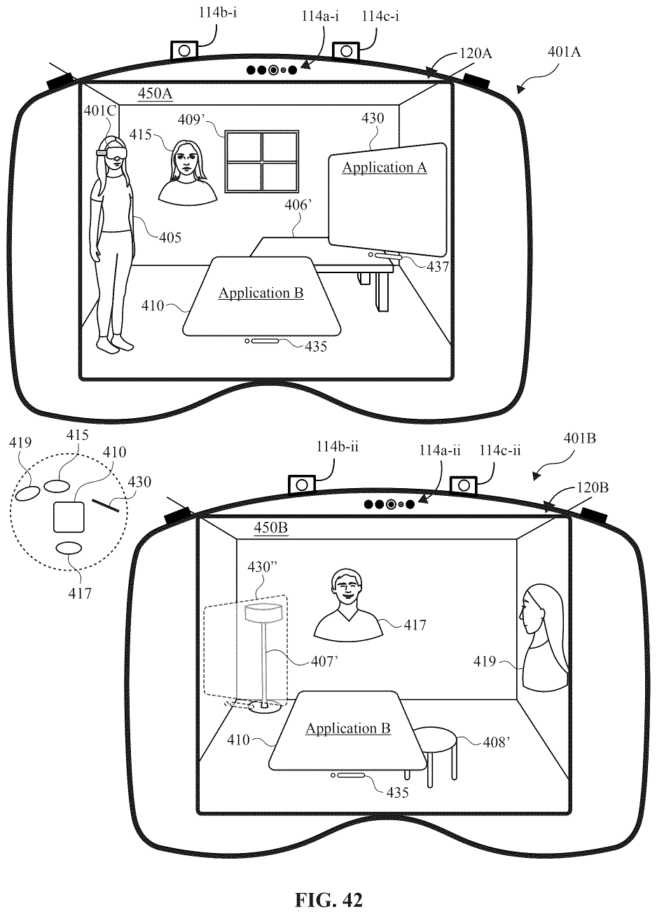

Turning ahead for purposes of discussion, FIG. 42 illustrates an example of a spatial group in a multi-user communication session that includes a plurality of electronic devices according to some examples of the disclosure. In some examples, a first electronic device 401A may present a three-dimensional environment 450A, and a second electronic device 401B may present a three-dimensional environment 450B. The first electronic device 401A and the second electronic device 401B may be similar to electronic device 101 or 201A/201B, and/or may be a head mountable system/device and/or projection-based system/device (including a hologram-based system/device) configured to generate and/or present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 42, a first user is optionally wearing the first electronic device 401A and a second user is optionally wearing the second electronic device 401B, such that the three-dimensional environment 450A/450B can be defined by X, Y and Z axes (or in other three-dimensional coordinate space coordinates) as viewed from a perspective of the electronic devices (e.g., a viewpoint associated with the electronic device 401A/401B, which may be a head-mounted display, for example).

As shown in FIG. 42, the first electronic device 401A may be in a first physical environment that includes a table 406 and a window 409. Thus, the three-dimensional environment 450A presented using the first electronic device 401A optionally includes captured portions of the physical environment surrounding the first electronic device 401A, such as a representation of the table 406′ and a representation of the window 409′. Similarly, the second electronic device 401B may be in a second physical environment, different from the first physical environment (e.g., separate in physical space from the first physical environment), that includes a floor lamp 407 and a coffee table 408. Thus, the three-dimensional environment 450B presented using the second electronic device 401B optionally includes captured portions of the physical environment surrounding the second electronic device 401B, such as a representation of the floor lamp 407′ and a representation of the coffee table 408′. Additionally, the three-dimensional environments 450A and 450B may include representations of the floor, ceiling, and walls of the room in which the first electronic device 401A and the second electronic device 401B are located, respectively.

In some examples, the first electronic device 401A and the second electronic device 401B are optionally in a multi-user communication session with third electronic device 401C. In some examples, a third user 405 is wearing the third electronic device 401C, which is optionally a head-mounted display, similar to the HMDs discussed above. In some examples, while the first electronic device 401A, the second electronic device 401B and the third electronic device 401C are in a multi-user communication session, the first electronic device 401A, the second electronic device 401B and the third electronic device 401C are configured to collaboratively present (e.g., via communication circuitry, such as communication circuitry 222A/222B in FIG. 2C) a shared three-dimensional environment (e.g., via their respective three-dimensional environments, such as three-dimensional environment 450A/450B) that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at a plurality of electronic devices via which content, applications, data, and the like may be shared and/or presented to users of the plurality of electronic devices.

In some examples, while the first electronic device 401A and the second electronic device 401B are in the multi-user communication session with the third electronic device 401C, a visual representation of a user of each electronic device is presented in the three-dimensional environment that is presented via the other electronic devices. In some examples, a type of visual representation that is presented at a respective electronic device within the multi-user communication session is based on whether the respective electronic device is collocated or non-collocated with the other electronic devices in the multi-user communication session, as described in more detail below.

In FIG. 42, the first electronic device 401A and the third electronic device 401C are collocated in the first physical environment. For example, the first electronic device 401A and the third electronic device 401C are both located in a same physical room that includes the table 406 and window 409. In some examples, the determination that the first electronic device 401A and the third electronic device 401C are collocated in the first physical environment is based on a distance between the first electronic device 401A and the third electronic device 401C. For example, in FIG. 42, the first electronic device 401A and the third electronic device 401C are collocated in the first physical environment because the first electronic device 401A is within a threshold distance (e.g., 0.1, 0.5, 1, 2, 3, 5, 10, 15, 20, etc. meters) of the third electronic device 401C. In some examples, the determination that the first electronic device 401A and the third electronic device 401C are collocated in the first physical environment is based on communication between the first electronic device 401A and the third electronic device 401C. For example, in FIG. 42, the first electronic device 401A and the third electronic device 401C are configured to communicate (e.g., wirelessly, such as via Bluetooth or other peer-to-peer communication networks, Wi-Fi, or a server (e.g., wireless communications terminal)) with each other. In some examples, the first electronic device 401A and the third electronic device 401C are connected to and/or are configured to communicate using a same wireless network in the first physical environment. In some examples, the determination that the first electronic device 401A and the third electronic device 401C are collocated in the first physical environment is based on a strength of a wireless signal transmitted between the first electronic device 401A and third electronic device 401C. For example, in FIG. 42, the first electronic device 401A and the third electronic device 401C are collocated in the first physical environment because a strength of a Bluetooth signal (or other wireless signal) transmitted between the first electronic device 401A and third electronic device 401C is greater than a threshold strength. In some examples, the determination that the first electronic device 401A and the third electronic device 401C are collocated in the first physical environment is based on visual detection of the first electronic device 401A and third electronic device 401C in the first physical environment. For example, as shown in FIG. 42, the third electronic device 401C is positioned in a field of view of the first electronic device 401A (e.g., because the third user 405 is standing in the field of view of the first electronic device 401A), which enables the first electronic device 401A to visually detect (e.g., identify or scan, such as via object detection or other image processing techniques) the third electronic device 401C (e.g., in one or more images captured by the first electronic device 401A, such as via external image sensors 114b-i and 114c-i). Similarly, in the example of FIG. 42, the first electronic device 401A is optionally positioned in a field of view of the third electronic device 401C (e.g., because the first user is standing in the field of view of the third electronic device 401C from a viewpoint of the third electronic device 401C), which enables the third electronic device 401C to visually detect the first electronic device 401A (e.g., in one or more images captured by the third electronic device 401C). In some examples, the determination that the first electronic device 401A and the third electronic device 401C are collocated in the first physical environment is based on visual detection of one or more same (e.g., overlapping) features or portions of the first physical environment. For example, as mentioned above, the first physical environment includes one or more physical objects, such as the window 409 and the table 406, and/or one or more physical surfaces, such as the walls, floor, and ceiling of the room in which the electronic devices 401A/401C are located. In the example of FIG. 42, the first electronic device 401A and the third electronic device 401C determine that the electronic devices are collocated in the first physical environment based on visual detection of the window 409, the table 406, and/or the walls and floor of the room, which are visible in the field of view of both of the electronic devices 401A/401C (e.g., in the one or more images captured by the first electronic device 401A and the third electronic device 401C).

On the other hand, in FIG. 42, the second electronic device 401B is non-collocated with the first electronic device 401A or the third electronic device 401C. For example, as shown in FIG. 42 and as mentioned above, the second electronic device 401B is located (e.g., with the second user) in the second physical environment (e.g., including the floor lamp 407 and coffee table 408), which is different from the first physical environment in which the first electronic device 401A and the third electronic device 401C are both located. In some examples, while the second electronic device 401B is in the second physical environment, the second electronic device 401B is more than the threshold distance (e.g., discussed above) of the first electronic device 401A and the third electronic device 401A. Additionally or alternatively, in some examples, as shown in FIG. 42, the second electronic device 401B is not in the field of view of the first electronic device 401A and/or the third electronic device 401C.

As mentioned above, while electronic devices are communicatively linked in a multi-user communication session, users of the electronic devices may be visually represented within the shared three-dimensional environment based at least in part on the determination of whether the electronic devices are collocated or non-collocated with each other. In FIG. 42, because the first electronic device 401A and the third electronic device 401C are collocated in the first physical environment as discussed above, the users of the first electronic device 401A and third electronic device 401C are represented in the multi-user communication session via their physical personas (e.g., bodies) that are visible directly or in passthrough of the first physical environment (e.g., rather than via virtual representations generated and displayed by the electronic devices). For example, as shown in FIG. 42, the third user 405 is visible in the field of view of the first electronic device 401A (e.g., and the first user is visible in the field of view of the third electronic device 401C in the first physical environment) while the first electronic device 401A and the third electronic device 401C are in the multi-user communication session. In some examples, because the second electronic device 401B is non-collocated with the first electronic device 401A and the third electronic device 401C in the first physical environment, the second user of the second electronic device 401B is visually represented via an avatar 415 in the three-dimensional environment 450A. Similarly, at the second electronic device 401B, an avatar 417 corresponding to the first user of the first electronic device 401A and an avatar 419 corresponding to the third user 405 of the third electronic device 401C are displayed in the three-dimensional environment 450B (e.g., because the first electronic device 401A and the third electronic device 401C are non-collocated with the second electronic device 401B in the second physical environment as discussed above).

In some examples, the presentation of avatars 415/417/419 as part of a shared three-dimensional environment is optionally accompanied by an audio effect corresponding to a voice of the users of the electronic devices 401A/401B/401C. For example, the avatar 415 displayed in the three-dimensional environment 450A using the first electronic device 401A is optionally accompanied by an audio effect corresponding to the voice of the user of the second electronic device 401B. In some such examples, when the user of the second electronic device 401B speaks, the voice of the user may be detected by the second electronic device 401B (e.g., via the one or more microphones 213B in FIG. 2C) and transmitted to the first electronic device 401A (e.g., via the communication circuitry 222B/222A), such that the detected voice of the user of the second electronic device 401B may be presented as audio (e.g., using one or more speakers 216A) to the user of the first electronic device 401A in three-dimensional environment 450A. In some examples, the audio effect corresponding to the voice of the user of the second electronic device 401B may be spatialized (e.g., may be outputted as spatial audio), such that it appears to the user of the first electronic device 401A to emanate from the location of avatar 415 in the shared three-dimensional environment 450A (e.g., despite being outputted from the speakers of the first electronic device 360). Similarly, the avatars 417/419 displayed in the three-dimensional environment 450B using the second electronic device 401B are optionally accompanied by an audio effect corresponding to the voices of the users of the first electronic device 401A and the third electronic device 401C, respectively. For example, when the user of the first electronic device 401A speaks, the voice of the user may be detected by the first electronic device 401A (e.g., via the one or more microphones 213A) and transmitted to the second electronic device 401B (e.g., via the communication circuitry 222A/222B), such that the detected voice of the user of the first electronic device 401A may be presented as audio (e.g., using one or more speakers 216B) to the user of the second electronic device 401B in three-dimensional environment 450B. In some examples, the audio effect corresponding to the voices of the user of the first electronic device 401A and the user of the third electronic device 401C may be spatialized, such that they appear to the user of the second electronic device 401B to emanate from the location of avatar 417 and/or the location of the avatar 419 in the three-dimensional environment 450B (e.g., despite being outputted from the speakers of the second electronic device 401B).

In some examples, while in the multi-user communication session, the avatars 415/417/419 are displayed in the shared three-dimensional environment with respective orientations that correspond to and/or are based on orientations of the electronic devices 401A/401B/401C (and/or the users of electronic devices 401A/401B/401C) in the physical environments surrounding the electronic devices 401A/401B/401C. For example, as shown in FIG. 42, in the three-dimensional environment 450A, the avatar 415 is optionally facing toward the viewpoint of the user of the first electronic device 401A, and in the three-dimensional environment 450B, the avatar 417 is optionally facing toward the viewpoint of the user of the second electronic device 401B. As a particular user moves the electronic device (and/or themself) in the physical environment, the viewpoint of the user changes in accordance with the movement, which may thus also change an orientation of the user's avatar in the three-dimensional environment. For example, with reference to FIG. 42, if the user of the first electronic device 401A were to look leftward in the three-dimensional environment 450A such that the first electronic device 401A is rotated (e.g., a corresponding amount) to the left (e.g., counterclockwise), the user of the second electronic device 401B would see the avatar 417 corresponding to the user of the first electronic device 401A rotate to the right (e.g., clockwise) relative to the viewpoint of the user of the second electronic device 401B in accordance with the movement of the first electronic device 401A.

Additionally, in some examples, while in the multi-user communication session, a field of view of the three-dimensional environments 450A/450B and/or a location of the viewpoint within the three-dimensional environments 450A/450B optionally changes in accordance with movement of the electronic devices 401A/401B/401C (e.g., by the users of the electronic devices 401A/401B/401C). For example, while in the communication session, when the first electronic device 401A is moved closer toward the representation of the table 406′ and/or the avatar 415 (e.g., because the user of the first electronic device 401A moved forward in the physical environment surrounding the first electronic device 401A), the field of view of the three-dimensional environment 450A would change accordingly, such that the representation of the table 406′, the representation of the window 409′ and the avatar 415 appear larger in the field of view. In some examples, each user may independently interact with the three-dimensional environment 450A/450B, such that changes in viewpoints within the three-dimensional environment 450A and/or interactions with virtual objects in the three-dimensional environment 450A by the first electronic device 401A optionally do not affect what is shown in the three-dimensional environment 450B at the second electronic device 401B, and vice versa.

In some examples, the avatars 415/417/419 are virtual representations (e.g., a full-body rendering) of the users of the electronic devices 401A/401B/401C. In some examples, a respective avatar is a representation of a portion or portions (e.g., a rendering of a head, face, head and torso, etc.) of the users of the electronic devices. In some examples, the avatars are user-personalized, user-selected, and/or user-created representations displayed in the three-dimensional environments 450A/450B that are representative of the users of the electronic devices 401A/401B/401C. It is understood that, while the avatars 415/417/419 illustrated in FIG. 42 correspond to bodily representations of the users of the electronic devices 401A/401B/401C, alternative avatars may be provided, such as those described above and/or having various dimensionality (e.g., three-dimensional or two-dimensional).

As used herein, relative to a first electronic device, a collocated user corresponds to a local user and a non-collocated user corresponds to a remote user. As similarly discussed above, the shared three-dimensional environment optionally includes avatars (e.g., avatars 415/417/419) corresponding to the remote users of the electronic devices that are non-collocated in the multi-user communication session. In some examples, the avatars corresponding to the remote users are generated and presented in the shared three-dimensional environment based on (e.g., using) skeletal data associated with the remote users. For example, the skeletal data is used to, at least partially, define one or more visual characteristics of the avatars (e.g., a size (e.g., height) and/or relative thickness of portions of the avatar, such as hands and/or limbs) in the three-dimensional environment. Additionally, the skeletal data is optionally used to track movement of the remote users, which, as discussed below, causes their corresponding avatars to be shifted and/or moved in the three-dimensional environment relative to the viewpoint of a first electronic device. In some examples, as discussed below, the skeletal data associated with local users may also be tracked and shared among the collocated electronic devices in the multi-user communication session to help facilitate presentation of and interaction with virtual objects (e.g., avatars and shared virtual content) in the three-dimensional environment.

As mentioned above, while the first electronic device 401A, the second electronic device 401B and the third electronic device 401C are in the multi-user communication session, their respective three-dimensional environments form and/or correspond to a shared three-dimensional environment that is presented using the electronic devices 401A/401B/401C. In some examples, content that is viewed by one user at one electronic device may be shared with another user at another electronic device in the multi-user communication session. In some such examples, the content may be experienced (e.g., viewed and/or interacted with) by multiple users (e.g., via their respective electronic devices) in the shared three-dimensional environment. For example, as shown in FIG. 42, the three-dimensional environments 450A/450B include a shared virtual object 410 (e.g., which is optionally a horizontally oriented board game associated with Application B) that is viewable by and interactive to the users of the electronic devices 401A/401B/401C. As shown in FIG. 42, the shared virtual object 410 is optionally displayed with a movement element 435 (e.g., a grabber affordance or handlebar or other user interface element) that is selectable to initiate movement of the shared virtual object 410 within the shared three-dimensional environment.

In some examples, the three-dimensional environments presented by the electronic devices include unshared content that is private to one or more users in the multi-user communication session. For example, in FIG. 42, the first electronic device 401A is displaying a private application window 430, which is optionally a virtual object that is not shared among the first electronic device 401A, the second electronic device 401B and the third electronic device 401C in the multi-user communication session. In some examples, the private application window 430 may be associated with a respective application (e.g., Application A) that is operating on the first electronic device 401A (e.g., such as a media player application, a web browsing application, a messaging application, etc.). Because the private application window 430 is not shared with the second electronic device 401B (e.g., or the third electronic device 401C), the second electronic device 401B optionally displays a representation of the private application window 430″ in three-dimensional environment 450B. As shown in FIG. 42, in some examples, the representation of the private application window 430″ may be a faded, occluded, discolored, and/or translucent representation of the private application window 430 that prevents the user of the second electronic device 401B (e.g., and the user of the third electronic device 401C) from viewing contents of the private application window 430.

As mentioned previously above, in some examples, the user of the first electronic device 401A, the user of the second electronic device 401B and the user of the third electronic device 401C are in and/or form a spatial group within the multi-user communication session. In some examples, the spatial group may be a baseline (e.g., a first or default) spatial group within the multi-user communication session. For example, when the user of the first electronic device 401A, the user of the second electronic device 401B and/or the user of the third electronic device 401C initially join the multi-user communication session, the user of the first electronic device 401A, the user of the second electronic device 401B, and the user of the third electronic device 401C are automatically (and initially) associated with (e.g., grouped into) the spatial group within the multi-user communication session. In some examples, while the users are in the spatial group as shown in FIG. 42, the user of the first electronic device 401A, the user of the second electronic device 401B and the user of the third electronic device 401C have a first spatial arrangement (e.g., arranged according to and/or defining a first spatial template) within the shared three-dimensional environment. For example, the user of the first electronic device 401A, the user of the second electronic device 401B, and the user of the third electronic device 401C, including objects that are shared and displayed in the shared three-dimensional environment, have spatial truth within the spatial group. In some examples, spatial truth requires a consistent spatial arrangement between users (or representations thereof) and shared virtual objects. For example, a distance between the viewpoint of the user of the first electronic device 401A and the avatar 415 corresponding to the user of the second electronic device 401B may be the same as a distance between the viewpoint of the user of the second electronic device 401B and the avatar 417 corresponding to the user of the first electronic device 401A. Similarly, in FIG. 42, a distance between the avatar 415 corresponding to the user of the second electronic device 401B and the physical location of the third electronic device 401C (e.g., including the third user 405) in the three-dimensional environment 450A from the viewpoint of the first electronic device 401A may be the same as a distance between the viewpoint of the user of the second electronic device 401B and the avatar 419 corresponding to the user of the third electronic device 401C in the three-dimensional environment 450B. As described herein, if the location of the viewpoint of the user of the first electronic device 401A moves, the avatar 417 corresponding to the user of the first electronic device 401A moves in the three-dimensional environment 450B in accordance with the movement of the location of the viewpoint of the user relative to the viewpoint of the user of the second electronic device 401B. As another example, if the user of the first electronic device 401A performs an interaction on the shared virtual object 410 (e.g., moves the virtual object 410 in the three-dimensional environment 450A), the second electronic device 401B (e.g., and the third electronic device 401C) alters or updates display of the shared virtual object 410 in the three-dimensional environment 450B in accordance with the interaction (e.g., moves the virtual object 410 by a corresponding (e.g., same) amount in the three-dimensional environment 450B). In the example of FIG. 42, the spatial group that is established among the first electronic device 401A, the second electronic device 401B, and the third electronic device 401C is a hybrid spatial group. For example, as defined herein, the multi-user communication session includes collocated and non-collocated users and electronic devices. Maintaining spatial truth among the viewpoints of the users in the multi-user communication session advantageously improves user interaction and experience of shared virtual objects and content. For example, it may be desirable to enable users who are collocated in a first physical environment and who are participating in a multi-user communication session with one or more users who are non-collocated in the first physical environment to coordinatively move and/or reposition virtual content that is shared and presented in a three-dimensional environment that is optionally viewable by and/or interactive to the collocated and non-collocated users in the multi-user communication session.

It is understood that, in some examples, fewer than and/or more than three electronic devices may be communicatively linked in a multi-user communication session. For example, in a situation in which two electronic devices are communicatively linked in a multi-user communication session, a first electronic device would present a single visual representation (e.g., a passthrough representation if collocated or a virtual representation (e.g., avatar) if non-collocated), rather than the two visual representations shown in FIG. 42, corresponding to the users of the other single electronic device. It should therefore be understood that the various processes and exemplary interactions described herein with reference to the first electronic device 401A, the second electronic device 401B, and the third electronic device 401C in the multi-user communication session illustrated in FIG. 42 optionally apply to situations in which fewer than or more than three electronic devices are communicatively linked in a multi-user communication session. It is also understood that, though illustrated in FIG. 42 as being such, a multi-user communication session need not include both collocated and non-collocated electronic devices (e.g., forming a hybrid spatial group). For example, a multi-user communication session can alternatively be established between solely collocated electronic devices (e.g., forming a local spatial group) or solely non-collocated electronic devices (e.g., forming a remote spatial group).

An electronic device may perform one or more operations based on a presence of a set of users of electronic devices that is collocated in a physical environment. In some examples, were a first electronic device associated with a first user to detect that it is collocated with a first set of users in the physical environment, the first electronic device would perform one or more operations contextualized to the first set of users. In some examples, were the first electronic device to detect that it is collocated with a second set of users in the physical environment that is different from the first set of users, the first electronic device would perform one or more operations contextualized to the second set of users. In some examples, were no set of users collocated with the first user in the physical environment, the first electronic device would perform one or more default operations. In some examples, the one or more operations contextualized to the first set of users includes display of data and/or user interfaces that were previously shared or used between the first user of the first electronic device and the first set of users. In some examples, the one or more operations contextualized to the second set of users includes display of data and/or user interfaces that were previously shared or used between the first user of the first electronic device and the second set of users. In some examples, the one or more operations are performed relative to a first application. For example, were a first electronic device to detect that it is collocated with the first set of users in the physical environment, the first electronic device would perform one or more operations contextualized to the first set of users relative to the first application, and were the first electronic device to detect that it is collocated with the second set of users in the physical environment, the first electronic device would perform one or more operations contextualized to the second set of users relative to the first application. As such, in some examples, the first electronic device can cause an application to behave differently based on the set of users in the physical environment that are collocated with the first user.

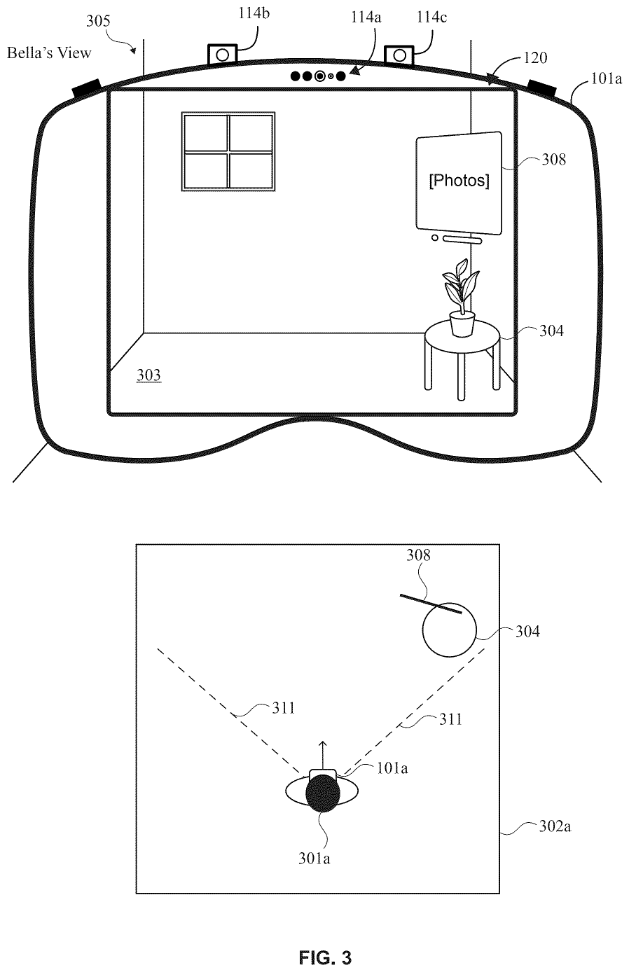

FIGS. 3 through 8B generally illustrate a first electronic device associated with a first user detecting and responding to being collocated in a physical environment with a second user of a second electronic device according to some examples of the disclosure.

FIG. 3 illustrates a first electronic device 101a presenting an extended reality environment (e.g., a three-dimensional environment 303) while in a physical environment 305 according to some examples of the disclosure. In FIG. 3, as illustrated in overhead view 302a (e.g., a top-down view), a first user 301a is wearing the first electronic device 101a. Note that FIGS. 3 through 40 include respective overhead views 302a through 302ll, which are applicable to the respective figures in which they appear. In FIG. 3, the display 120 has a field of view (e.g., a field of view captured by external image sensors 114b and 114c and/or visible to the user via the display 120) that corresponds to the content shown in FIG. 3. For example, in FIG. 3, the viewing boundaries of the first user 301a via the first electronic device 101a are given by the viewing boundaries 311. Because the display 120 is optionally a head-mounted device, the field of view of display 120 is optionally the same as or similar to the field of view of the user. For example, the view of the three-dimensional environment 303 depicts what is visible to the first user 301a (via display 120) when the viewpoint of the first electronic device 101a is located as shown in the overhead view 302a of the three-dimensional environment 303 and the first electronic device 101a is optionally oriented in the direction indicated by the direction arrow emanating from the first electronic device 101a in the overhead view 302a.

Further, in FIG. 3, the first electronic device 101a optionally captures one or more images of the physical environment 305 around the first electronic device 101a, including one or more objects and/or users in the physical environment 305 around the first electronic device 101a (should they be in the physical environment 305 around the first electronic device 101a). In some examples, the first electronic device 101a displays representations of the physical environment 305 in the three-dimensional environment 303. For example, the three-dimensional environment 303 in FIG. 3 optionally includes representations of the rear and side walls (e.g., including the glass window shown in the upper left corner of display 120) of the room (e.g., the physical environment 305) in which the first electronic device 101a is located and a representation of a table 304 (e.g., a physical table on which a physical potted plant sits) located in the room in which the first electronic device 101a is located.

In FIG. 3, the display 120 of the first electronic device 101a shows a three-dimensional environment 303 that includes a photos user interface 308 (e.g., a user interface of a photos application). In FIG. 3, the first electronic device 101a is displaying the photos user interface 308, and the first user 301a may interact with the photos user interface 308 (e.g., via user input detected via the first electronic device 101a, such as via image sensors 114a-114c).

The first electronic device 101a optionally includes one or more features of the electronic device 101, the first electronic device 260, or the second electronic device 270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user 301a is wearing the first electronic device 101a, such that the three-dimensional environment 303 can be defined by X, Y and Z axes as viewed from a perspective of the first electronic device 101a (e.g., a viewpoint associated with the first electronic device 101a, which may be a head-mounted display, for example).

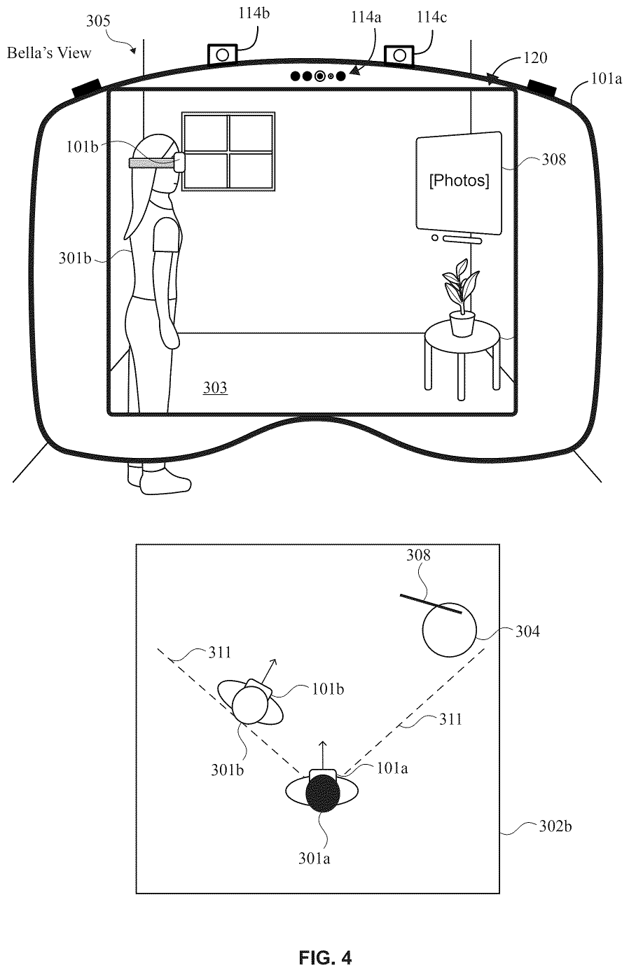

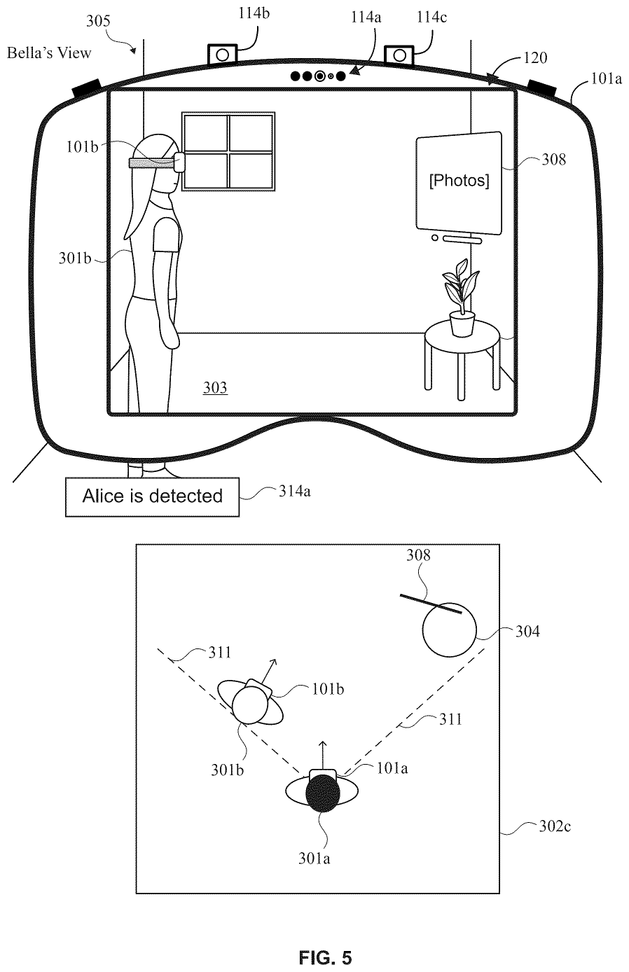

From FIG. 3 to FIG. 4, a second user 301b of a second electronic device 101b enters the physical environment 305 in which the first electronic device 101a is located. For example, the second user 301b optionally enters the same room that the first electronic device 101a is located. The second electronic device 101b optionally includes one or more features described with reference to the electronic device 101 (e.g., of FIG. 1), the first electronic device 260 (e.g., of FIG. 2), electronic device 270 (e.g., of FIG. 2), and/or the first electronic device 101a. While the second user 301b of the second electronic device 101b is in the physical environment 305, the first electronic device 101a detects that the first electronic device 101a is collocated with the second electronic device 101b in the physical environment 305 (e.g., the first electronic device 101a detects that the first user 301a of the first electronic device 101a is collocated in the physical environment 305 with the second user 301b of the second electronic device 101b), such as shown in FIG. 5, and such as described below.

In FIG. 5, the first electronic device 101a and the second electronic device 101b are collocated in the physical environment 305, as shown by the notice 314a that indicates that “Alice is detected”.

In some examples, the first electronic device 101a and the second electronic device 101b are determined to be collocated because the first electronic device 101a and the second electronic device 101b are located in the same physical room. In some examples, were the first electronic device 101a and the second electronic device 101b not in the same physical room, it would be determined that the first electronic device 101a and the second electronic device 101b are not collocated.

In some examples, the determination that the first electronic device 101a and the second electronic device 101b are collocated in the physical environment 305 is based on a distance between the first electronic device 101a and the second electronic device 101b. For example, in FIG. 5, the first electronic device 101a and the second electronic device 101b are collocated in the physical environment 305 because the first electronic device 101a is within a threshold distance (e.g., 0.1, 0.5, 1, 2, 3, 5, 10, 15, 20, etc. meters) of the second electronic device 101b (e.g., the first electronic device 101a detects that the second electronic device 101b is within the threshold distance). Were the first electronic device 101a and the second electronic device 101b not within the threshold distance (e.g., were the first electronic device 101a to detect that the second electronic device 101b is not within the threshold distance), the first electronic device 101a and the second electronic device 101b may not be collocated.

In some examples, the determination that the first electronic device 101a and the second electronic device 101b are collocated in the physical environment 305 is based on communication between the first electronic device 101a and the second electronic device 101b. For example, in FIG. 5, the first electronic device 101a and the second electronic device 101b may communicate (e.g., wirelessly, such as via BLUETOOTH, Wi-Fi, or a server (e.g., wireless communications terminal), with each other). For example, one or more signals transmitted by the first electronic device 101a may be detected by receptors at the second electronic device 101b, and/or one or more signals transmitted by the second electronic device 101b may be detected by receptors at the first electronic device 101a. Were no signal transmitted from the first electronic device 101a or detected by the second electronic device 101b, it may be determined that the first electronic device 101a and the second electronic device 101b are not collocated. Similarly, were no signal transmitted from the second electronic device 101b or detected by the first electronic device 101a, it may be determined that the first electronic device 101a and the second electronic device 101b are not collocated.

In some examples, the determination that the first electronic device 101a and the second electronic device 101b are collocated in the physical environment 305 is based on a strength of a wireless signal transmitted and detected between the first electronic device 101a and the second electronic device 101b. For example, in FIG. 5, the first electronic device 101a and the second electronic device 101b are collocated in the physical environment 305 because a strength of a BLUETOOTH signal (or other wireless signal) transmitted and detected between the first electronic device 101a and the second electronic device 101b is greater than a threshold strength. For example, were the second electronic device 101b to detect a BLUETOOTH signal from the first electronic device 101a that is greater than a threshold signal strength, it may be determined that the first electronic device 101a and the second electronic device 101b are collocated. Similarly, were the first electronic device 101a to detect a BLUETOOTH signal from the second electronic device 101b that is greater than a threshold signal strength, it may be determined that the first electronic device 101a and the second electronic device 101b are collocated. Furthermore, were the second electronic device 101b to detect a BLUETOOTH signal from the first electronic device 101a that is less than the threshold signal strength, it may be determined that the first electronic device 101a and the second electronic device 101b are not collocated and/or that wireless transmission features or wireless reception features are turned off at the first electronic device 101a and/or the second electronic device 101b. Similarly, were the first electronic device 101a to detect a BLUETOOTH signal from the second electronic device 101b that is less than the threshold signal strength, it may be determined that the first electronic device 101a and the second electronic device 101b are not collocated and/or that wireless transmission features or wireless reception features are turned off at the second electronic device 101b and/or the first electronic device 101a.

In some examples, the determination of the collocation of the first electronic device 101a and the second electronic device 101b is based on them being connected to a same network (e.g., wireless network) in the physical environment 305. For example, were it determined that the first electronic device 101a and the second electronic device 101b are connected to the same wireless network, it may be determined that the first electronic device 101a and the second electronic device 101b are collocated. Continuing with this example, were it determined that the first electronic device 101a and the second electronic device 101b are not connected to the same wireless network, it may be determined that the first electronic device 101a and the second electronic device 101b are not collocated.

In some examples, the determination that the first electronic device 101a and the second electronic device 101b are collocated in the physical environment 305 is based on visual detection of the first electronic device 101a and the second electronic device 101b in the physical environment 305. For example, as shown in FIG. 5, the second electronic device 101b is positioned in a field of view of the first electronic device 101a, which enables the first electronic device 101a to visually detect (e.g., identify or scan, such as via object detection/recognition or other image processing techniques) the second electronic device 101b (e.g., in one or more images captured by the first electronic device 101a, such as via external image sensors 114b and 114c). Additionally, were the first electronic device 101a in a field of view of the second electronic device 101b, it may be determined that the first electronic device 101a and the second electronic device 101b are collocated. Further, were the second electronic device 101b not in the field of view of the first electronic device 101a, it may be determined that the first electronic device 101a and the second electronic device 101b are not collocated. Similarly, were the first electronic device 101a not in the field of view of the second electronic device 101b, it may be determined that the first electronic device 101a and the second electronic device 101b are not collocated. Note that were the first electronic device 101a to detect the second electronic device 101b via image sensors of the first electronic device 101a, without the second electronic device 101b detecting the first electronic device 101a via image sensors of the second electronic device 101b, it may be determined that the first electronic device 101a and the second electronic device 101b are collocated. Similarly, note that were the second electronic device 101b to detect the first electronic device 101a via image sensors of the second electronic device 101b, without the first electronic device 101a detecting the second electronic device 101b via image sensors of the first electronic device 101a, it may be determined that the first electronic device 101a and the second electronic device 101b are collocated.

In some examples, the determination that the first electronic device 101a and the second electronic device 101b are collocated in physical environment 305 is based on the user of the other electronic device being in a contact list of the electronic device. For example, the first electronic device 101a and the second electronic device 101b may be collocated in physical environment 305 because the first user 301a of the first electronic device 101a and the second user 301b of the second electronic device 101b are in the physical environment 305 and the first user 301a of the first electronic device 101a is in a contact list on the second electronic device 101b (e.g., a contact list of an application accessible via the second electronic device 101b, such as a phone application, a contact list application, an email application, a communication application, or another type of application). Additionally or alternatively, as another example, the first electronic device 101a and the second electronic device 101b may be collocated in physical environment 305 because the first user 301a of the first electronic device 101a and the second user 301b of the second electronic device 101b are in the physical environment 305 and the user second 102b of the second electronic device 101b is in a contact list on the first electronic device 101a (e.g., a contact list of an application accessible via the first electronic device 101a, such as a phone application, a contact list application, an email application, a communication application, or another type of application). In some examples, were the first user 301a of the first electronic device 101a not in a contact list on the second electronic device 101b and/or were the second user 301b of the second electronic device 101b not in a contact list on the first electronic device 101a, it may be determined that the first electronic device 101a and the second electronic device 101b are not collocated in physical environment 305 even if they are in physical environment 305. Note that, in some examples, the first electronic device 101a and the second electronic device 101b may be determined to be collocated if the second user 301b of the second electronic device 101b is in the contact list on the first electronic device 101a, without the first user 301a being in a contact list on the second electronic device 101b. Note that, in some examples, the first electronic device 101a and the second electronic device 101b may be determined to not be collocated if the second user 301b of the second electronic device 101b is in the contact list on the first electronic device 101a, without the first user 301a being in a contact list on the second electronic device 101b.

Note that in FIG. 5, the detection of collocation of the first electronic device 101a with the second electronic device 101b includes detection of the user associated with the second electronic device 101b. For example, in FIG. 5, as shown with indication or notice 314a, which is representatively provided (e.g., is not necessarily displayed), the first electronic device 101a senses that it is collocated in the physical environment 305 with the specific user of the second electronic device 101b, namely second user 301b (e.g., “Alice”). Alice is optionally the name or username of the user that is logged into the second electronic device 101b. In some examples, the communications between the first electronic device 101a and the second electronic device 101b include data indicative of one or more identifiers of the one or more respective users of the one or more respective electronic devices that indicate that the one or more respective users are logged into one or more user accounts associated with the one or more respective electronic devices, and the determination of the collocation of the electronic devices is optionally based on this detection. Further, note that when it is determined (e.g., detected) that the first electronic device 101a and the second electronic device 101b are collocated, the user of the first electronic device 101a and the user of the second electronic device 101b are likewise determined to be collocated.

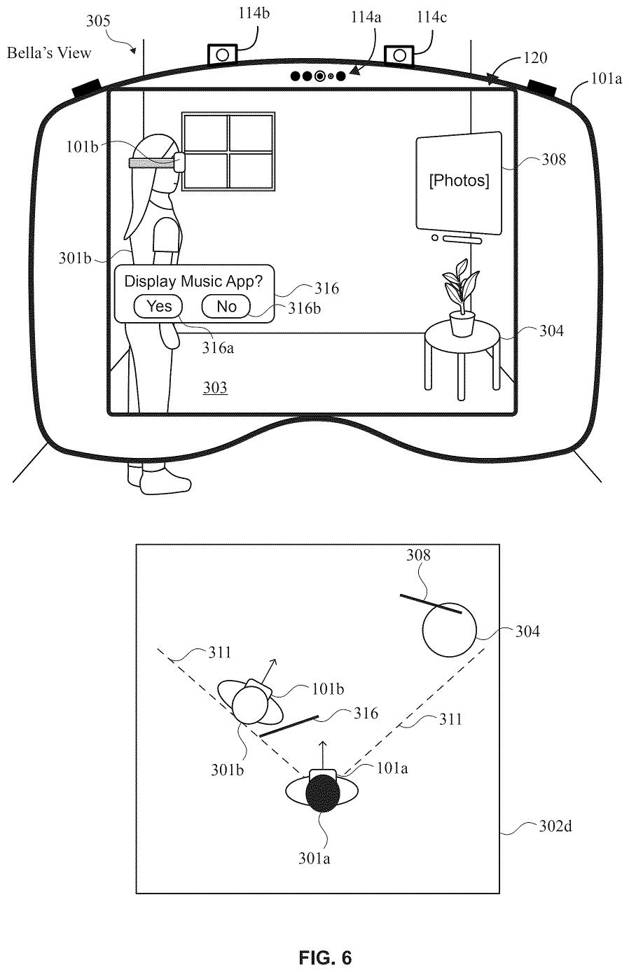

In some examples, the second user 301b of the second electronic device 101b previously interacted with the first user 301a of the first electronic device 101a. For example, the first user 301a may have played a virtual game with, emailed, texted, and/or called, or video called the second user 301b, and/or the second user 301b may have played a virtual game with, emailed, texted, and/or called, or video called the first user 301a. As another example, the first user 301a and the second user 301b may have interacted with an application while previously collocated in a physical environment (e.g., the physical environment 305 or another physical environment). In some examples, the first electronic device 101a senses (e.g., accesses from memory or storage, or from a remote server) the type(s) of previous interactions between the first user 301a of the first electronic device 101a and the second user 301b of the second electronic device 101b. For example, the first electronic device 101a optionally senses which applications (e.g., gaming applications, calling application, an Internet application, and/or other applications) were previously used between the first user 301a of the first electronic device 101a and the second user 301b of the second electronic device 101b. In some examples, in response to detecting that the first electronic device 101a and the second electronic device 101b are collocated in the physical environment 305, the first electronic device 101a displays one or more suggestions that are contextualized to the second user 301b (e.g., and optionally that are based on those previous interactions between the first user 301a and the second user 301b), such as shown from FIG. 5 to FIG. 6.

In particular, while presenting the view of the three-dimensional environment 303 shown in FIG. 5, and in response to detecting that the second electronic device 101b is collocated with the first electronic device 101a in the physical environment 305, the first electronic device 101a displays the suggestion element 316 (e.g., a suggestion user interface element), as shown in FIG. 6. In FIG. 6, the suggestion element 316 is a user interface element that is selectable to display a first user interface of a first application. In some examples, the suggestion element 316 is also selectable to cause the second electronic device 101b to display the first user interface of the first application (e.g., the first electronic device 101a would share the first user interface with the second electronic device 101b, such that both the first user 301a and the second user 301b may experience and interact with the first user interface together). In some examples, the suggestion element 316 indicates one or more of the ways the first user 301a of the first electronic device 101a has previously interacted with the second user 301b of the second electronic device 101b.

In some examples, the suggestion element 316 of FIG. 6 is selectable to display a user interface of an application that was previously shared or used between the first user 301a and the second user 301b independent of whether the first user 301a and the second user 301b were collocated or not when the user interface of the application was previously shared or used between them. In some examples, the suggestion element 316 of FIG. 6 is selectable to display a user interface of an application that was previously shared or used between the first user 301a and the second user 301b when they were previously collocated in a physical environment, such as the application being previously shared or used between the first user 301a and the second user 301b while in a multi-user communication session (e.g., a previously active multi-user communication session) that includes the first user 301a and the second user 301b and while the first user 301a and the second user 301b were collocated in a physical environment. For instance, in the example of FIG. 6, the suggestion element 316 is selectable to display a user interface of a music application optionally because the music application was previously shared or used between the first user 301a and the second user 301b when they were previously collocated in a physical environment. In some examples, were the first user 301a and the second user 301b to have previously interacted with multiple applications, the first electronic device 101a displays a respective suggestion element for each application that they have previously interacted with, optionally with an order of priority in a list that is based on an amount of previous usage and/or how recent the interaction/usage was. In some examples, were the first user 301a and the second user 301b to have previously interacted with multiple applications, the first electronic device 101a displays a respective suggestion element for each application up to two, three, or four, or another number of applications. In some examples, were the first user 301a and the second user 301b to have previously interacted with multiple applications, the first electronic device 101a displays a suggestion element for just the most recently used application between the first user 301a and the second user 301b. In some examples, the suggestion element 316 of FIG. 6 includes a list or other indication of how the first user 301a and the second user 301b previously interacted.

In some examples, the first electronic device 101a displays the suggestion element 316 at a location in the three-dimensional environment 303 that is based on a spatial arrangement between the current viewpoint of the first electronic device 101a and the second user 301b. In some examples, were the spatial arrangement between the current viewpoint of the first electronic device 101a and the second user 301b a first spatial arrangement, the first electronic device 101a would optionally display the suggestion element 316 at a first location in the three-dimensional environment 303. In some examples, were the spatial arrangement between the current viewpoint of the first electronic device 101a and the second user 301b a second spatial arrangement that is different from the first spatial arrangement, the first electronic device 101a would display the suggestion element 316 at a second location in the three-dimensional environment 303 that is different from the first location in the three-dimensional environment 303.

In FIG. 6, the first electronic device 101a displays the suggestion element 316 in front of the second user 301b from the viewpoint of the first electronic device 101a. In some examples, the first electronic device 101a displays the suggestion element 316 of FIG. 6 at a predetermined location relative to the second user 301b from the viewpoint of the first electronic device 101a, such as in front of, to the left of, to the right of, on, below, above, or at another predetermined location relative to the second user 301b from the current viewpoint of the first electronic device 101a.

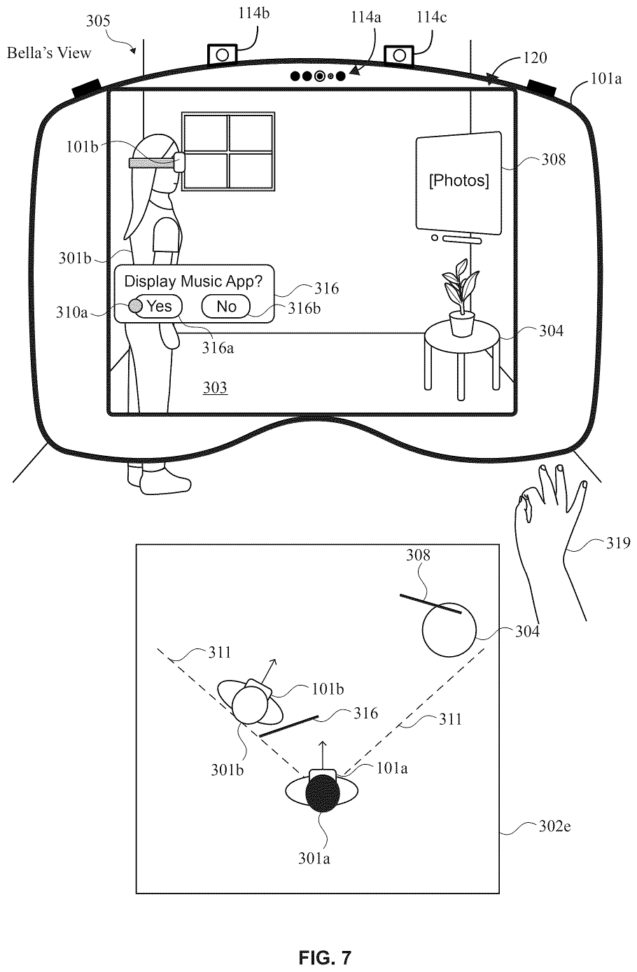

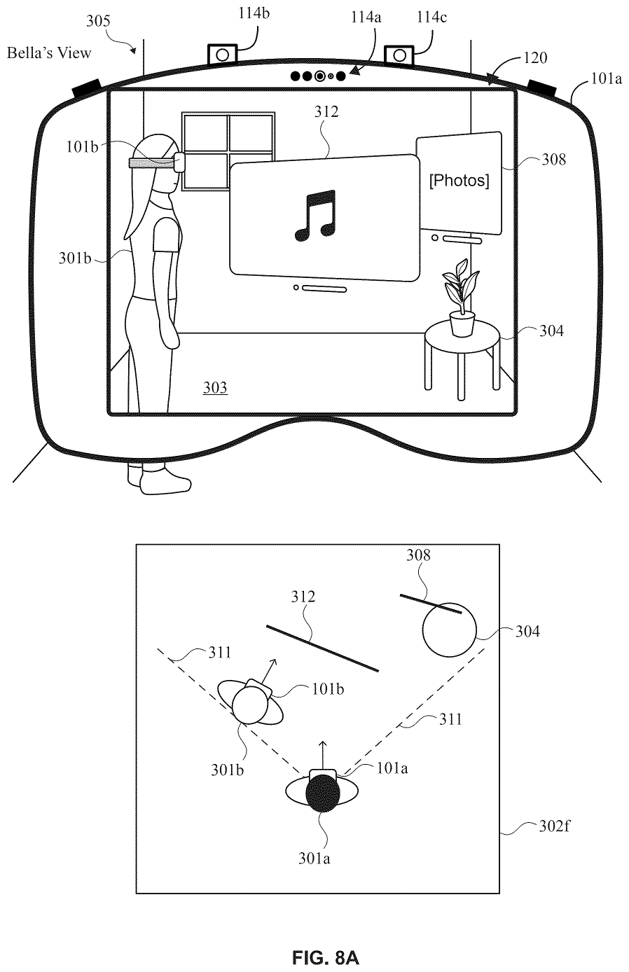

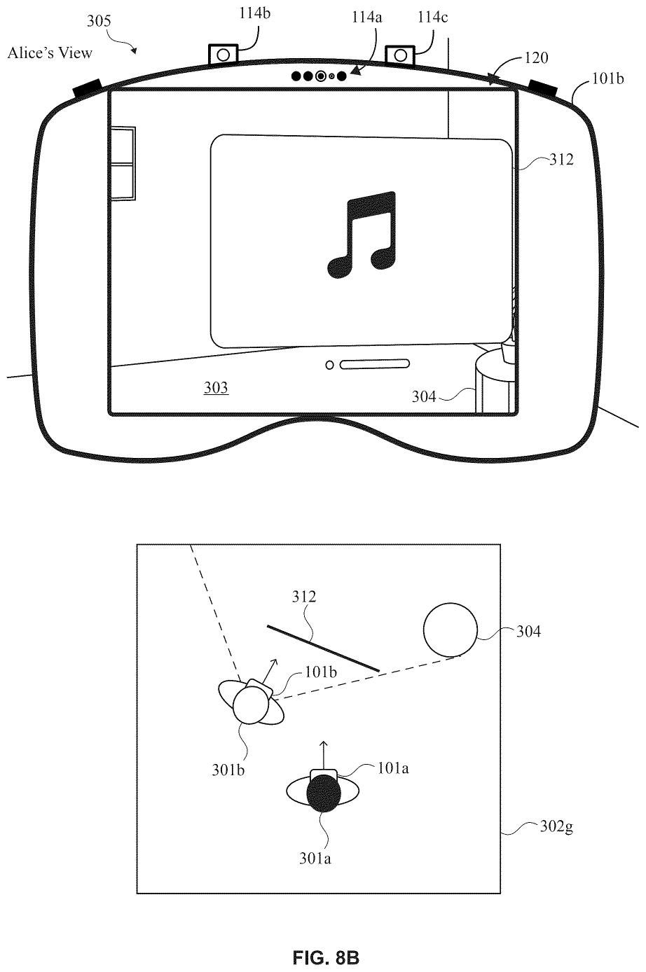

While the presenting the view of the three-dimensional environment 303 shown in FIG. 6, the first electronic device 101a detects selection of the suggestion element 316, as shown in FIG. 7. For example, in FIG. 7, the first electronic device 101a optionally detects the hand 319 of the first user 301a performing an air pinch gesture directed to the suggestion element 316 (e.g., a tapping of the index finger with the thumb of the first user 301a) while attention (e.g., gaze) of the first user 301a is directed to an option 316a of the suggestion element 316, as shown with gaze point 310a. In some examples, the first electronic device 101a detects a gaze of the first user 301a and/or an air gesture directed to the option 316a of the suggestion element 316. Additionally or alternatively, the first electronic device 101a optionally detects a voice input, an input via a mouse, touch screen or trackpad, or another type of input described herein that is directed to the option 316a of the suggestion element 316. In response to detecting the selection in FIG. 7, the first electronic device 101a (ceases display of the suggestion element 316) and displays the user interface 312 of a music application, as shown in FIG. 8A. FIG. 8A illustrates the first electronic device 101a displaying the user interface 312 of the music application in response to detection the selection in FIG. 7. In some examples, in response to detecting the selection in FIG. 7, the first electronic device 101a also shares the user interface 312 of the music application with the second electronic device 101b, so that both the first user 301a of the first electronic device 101a and the second user 301b of the second electronic device 101b can experience the virtual content together via their respective electronic devices as described above, such as shown in FIGS. 8A and 8B. FIG. 8A illustrates the first electronic device 101a displaying the user interface 312 of the music application in response to detection of the selection in FIG. 7, and FIG. 8B illustrates the second electronic device 101b displaying the user interface 312 of the music application in response to the sharing initiated by the first electronic device 101a. Note in FIG. 8B, the second electronic device 101b does not display the photos user interface 308 that the first electronic device 101a displays in FIG. 8A because the photos user interface 308 is not being shared (e.g., it is private to the first electronic device 101a).

Note that were the first electronic device 101a to detect selection of the option 316b of the suggestion element 316 instead of selection of the option 316a of the suggestion element 316 in FIG. 7, the first electronic device 101a would optionally cease displaying the suggestion element 316 and not display the user interface 312 of the music application.

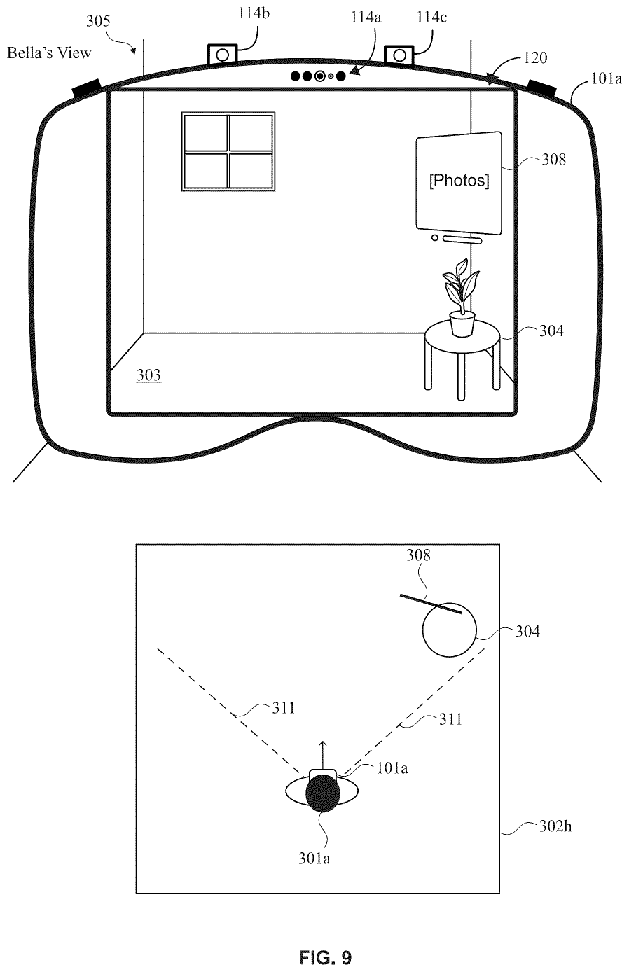

FIGS. 9 through 14 generally illustrate the first electronic device 101a detecting and responding to being collocated in the physical environment 305 with a third user 301c of a third electronic device 101c (e.g., and not with the second user 301b) according to some examples of the disclosure.

FIG. 9 illustrates the first electronic device 101a presenting a view of the three-dimensional environment 303 while in the physical environment 305, such as described with reference to FIG. 3.

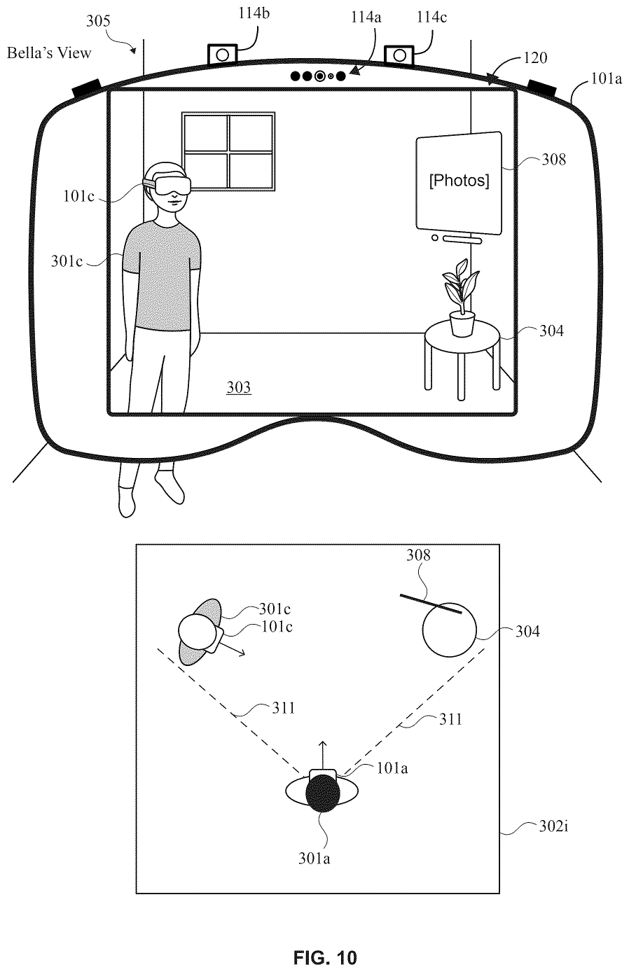

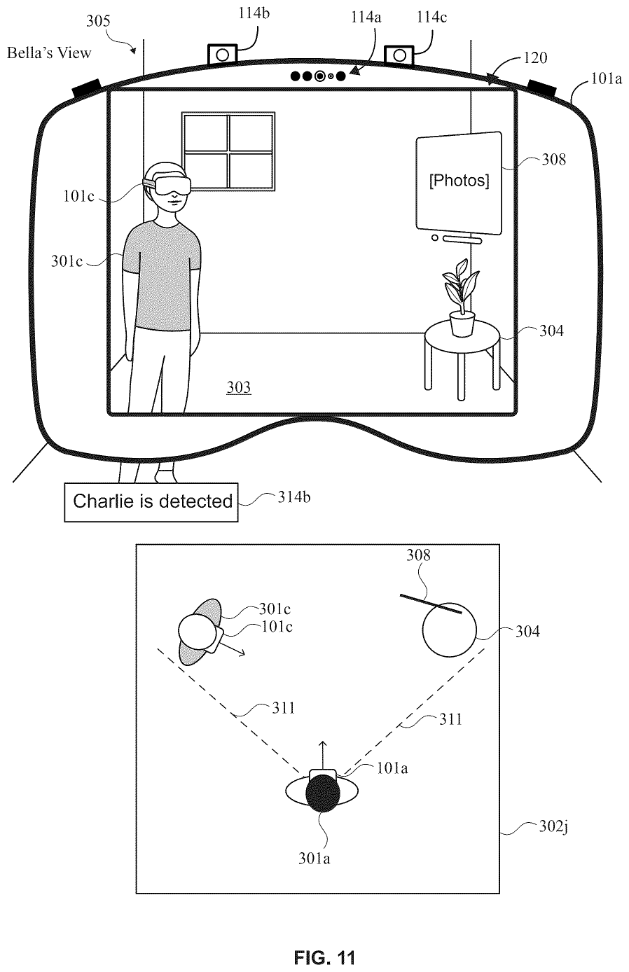

From FIG. 9 to FIG. 10, the third user 301c of the third electronic device 101c enters the physical environment 305 in which the first electronic device 101a is located. For example, the third user 301c optionally enters the same room that the first electronic device 101a is located. The third electronic device 101c optionally includes one or more features described with reference to the electronic device 101 (e.g., of FIG. 1), the first electronic device 260 (e.g., of FIG. 2), the second electronic device 270 (e.g., of FIG. 2), the first electronic device 101a, and/or the second electronic device 101b. The third electronic device 101c is optionally different from the first electronic device 101a. The third user 301c is optionally different from the second user 301b. While the third user 301c of the third electronic device 101c is in the physical environment 305, the first electronic device 101a detects that the first electronic device 101a is collocated with the third electronic device 101c in the physical environment 305, such as shown in FIG. 11.

In FIG. 11, the first electronic device 101a and the third electronic device 101c are determined to be collocated in the physical environment 305, as shown by the notice 314b that indicates that “Charlie is detected” (e.g., Charlie optionally corresponds to a name of the third user 301c). In some examples, the first electronic device 101a detects that the first electronic device 101a is collocated with the third electronic device 101c as described with reference to the first electronic device 101a detecting that the first electronic device 101a is collocated with the second electronic device 101b. Indeed, one or more or all descriptions herein directed to examples of ways it may be determined that the first electronic device 101a and the second electronic device 101b are collocated in the physical environment 305 are applicable to a determination that the first electronic device 101a is collocated with the third electronic device 101c in the physical environment 305. For example, the determination that the first electronic device 101a and the third electronic device 101c are collocated in physical environment 305 is optionally based on the user of the other electronic device being in a contact list of the electronic device. For example, the first electronic device 101a and the third electronic device 101c may be collocated in physical environment 305 because the first user 301a of the first electronic device 101a and the third user 301c of the third electronic device 101c are in the physical environment 305 and the first user 301a of the first electronic device 101a is in a contact list on the third electronic device 101c (e.g., a contact list of an application accessible via the third electronic device 101c, such as a phone application, a contact list application, an email application, a communication application, or another type of application). Additionally or alternatively, as another example, the first electronic device 101a and the third electronic device 101c may be collocated in physical environment 305 because the first user 301a of the first electronic device 101a and the third user 301c of the third electronic device 101c are in the physical environment 305 and the third user 301c of the third electronic device 101c is in a contact list on the first electronic device 101a (e.g., a contact list of an application accessible via the first electronic device 101a, such as a phone application, a contact list application, an email application, a communication application, or another type of application). In some examples, were the first user 301a of the first electronic device 101a not in a contact list on the third electronic device 101c and/or were the third user 301c of the third electronic device 101c not in a contact list on the first electronic device 101a, it may be determined that the first electronic device 101a and the second electronic device 101b are not collocated in physical environment 305 even if they are in physical environment 305. Note that, in some examples, the first electronic device 101a and the third electronic device 101c may be determined to be collocated if the third user 301c of the third electronic device 101c is in the contact list on the first electronic device 101a, without the first user 301a being in a contact list on the third electronic device 101c. Note that, in some examples, the first electronic device 101a and the third electronic device 101c may be determined to not be collocated if the third user 301c of the third electronic device 101c is in the contact list on the first electronic device 101a, without the first user 301a being in a contact list on the third electronic device 101c.

Further, note that in FIG. 11, the detection of collocation of the first electronic device 101a with the third electronic device 101c includes detection of the user associated with the third electronic device 101c. For example, in FIG. 11, as shown with the indication or notice 314b, which is representatively provided in the figure (e.g., is not necessarily displayed by the first electronic device 101a), the first electronic device 101a senses that it is collocated with the specific user of the third electronic device 101c, namely third user 301c (e.g., “Charlie”). Charlie is optionally the name or username of the user that is logged into the third electronic device 101c. In some examples, the communications between the first electronic device 101a and the third electronic device 101c include one or more identifiers of the one or more respective users of the one or more respective electronic devices that indicate that the one or more respective users are logged into one or more user accounts associated with the one or more respective electronic devices, and the determination of the collocation of the electronic devices is optionally based on this detection. Further, note that when it is determined that the first electronic device 101a and the third electronic device 101c are collocated, the first user 301a of the first electronic device 101a and the third user 301c of the third electronic device 101c are likewise determined to be collocated.

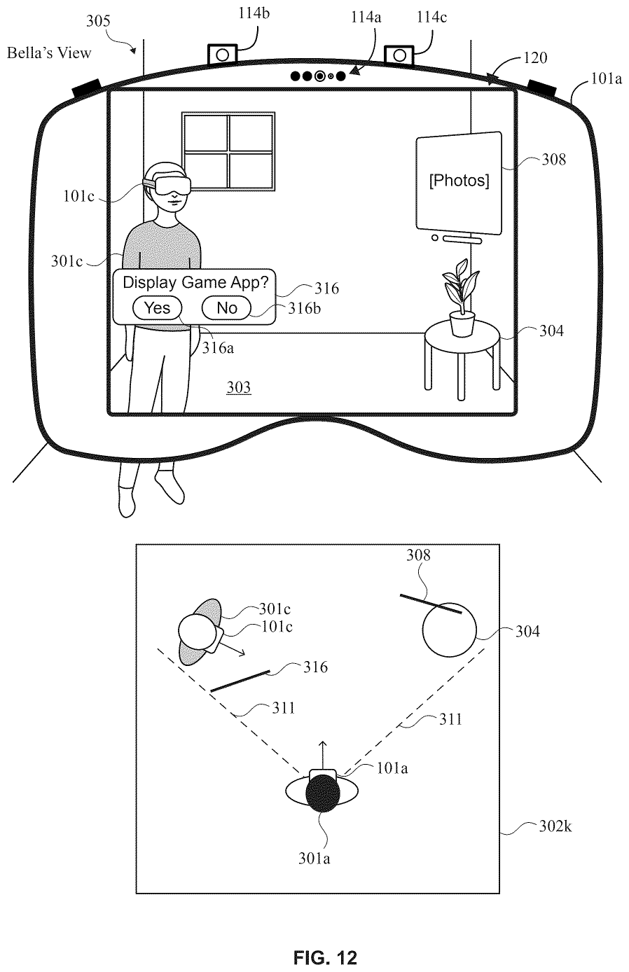

In some examples, the third user 301c of the third electronic device 101c previously interacted with the first user 301a of the first electronic device 101a. For example, the first user 301a may have played a virtual game with, emailed, texted, and/or called, or video called the third user 301c, and/or the third user 301c may have played a virtual game with, emailed, texted, and/or called, or video called the first user 301a. As another example, the first user 301a and the third user 301c may have interacted with an application while previously collocated in a physical environment (e.g., the physical environment 305 or another physical environment). In some examples, the first electronic device 101a senses the type(s) of previous interactions between the first user 301a of the first electronic device 101a and the third user 301c of the third electronic device 101c. For example, the first electronic device 101a optionally senses (e.g., accesses from memory or storage, or from a remote server) which applications (e.g., gaming applications, calling application, an Internet application, and/or other applications) were previously used between the first user 301a of the first electronic device 101a and the third user 301c of the third electronic device 101c. In some examples, in response to detecting that the first electronic device 101a and the third electronic device 101c are collocated in the physical environment 305, the first electronic device 101a displays one or more suggestions that are contextualized to the third user 301c (e.g., and optionally that are based on those previous interactions between the first user 301a and the third user 301c), such as shown from FIG. 11 to FIG. 12.

In particular, while the presenting the view of the three-dimensional environment 303 shown in FIG. 11, and in response to detecting that the third electronic device 101c is collocated with the first electronic device 101a in the physical environment 305, the first electronic device 101a displays the suggestion element 316 (e.g., a suggestion user interface element), as shown in FIG. 12. In FIG. 12, the suggestion element 316 is a user interface element that is selectable to display a user interface of an application. In some examples, the suggestion element 316 is also selectable to cause the third electronic device 101c to display the user interface of the application (e.g., the first electronic device 101a would share the first user interface with the third electronic device 101c, such that both the first user 301a and the third user 301c may experience and interact with the second user interface together).

In some examples, the suggestion element 316 of FIG. 12 is selectable to display a user interface of an application that was previously shared or used between the first user 301a and the third user 301c independent of whether the first user 301a and the third user 301c were collocated or not when the user interface of the application was previously shared or used between them. In some examples, the suggestion element 316 of FIG. 12 is selectable to display a user interface of an application that was previously shared or used between the first user 301a and the third user 301c when they were previously collocated in a physical environment. For example, in the illustrated example of FIG. 12, the suggestion element is selectable to display a user interface of a gaming application optionally because the gaming application was previously shared or used between the first user 301a and the third user 301c when the first user 301a and the third user 301c were previously collocated in a physical environment. In some examples, were the first user 301a and the third user 301c to have previously interacted with multiple applications, the first electronic device 101a displays a respective suggestion element for each application that they have previously interacted with, optionally with an order of priority in a list that is based on an amount of previous usage and/or how recent the interaction/usage was. In some examples, were the first user 301a and the third user 301c to have previously interacted with multiple applications, the first electronic device 101a displays a respective suggestion element for each application up to two, three, or four, or another number of applications. In some examples, were the first user 301a and the third user 301c to have previously interacted with multiple applications, the first electronic device 101a displays a suggestion element for just the most recently used application between the first user 301a and the third user 301c. In some examples, the suggestion element 316 of FIG. 12 includes a list or other indication of how the first user 301a and the third user 301c previously interacted.

In some examples, the first electronic device 101a displays the suggestion element 316 in FIG. 12 at a location in the three-dimensional environment 303 that is based on a spatial arrangement between the current viewpoint of the first electronic device 101a and the third user 301c. In some examples, were the spatial arrangement between the current viewpoint of the first electronic device 101a and the third user 301c a first spatial arrangement, the first electronic device 101a would optionally display the suggestion element 316 at a first location in the three-dimensional environment 303. In some examples, were the spatial arrangement between the current viewpoint of the first electronic device 101a and the third user 301c a second spatial arrangement that is different from the first spatial arrangement, the first electronic device 101a would display the suggestion element 316 at a second location in the three-dimensional environment 303 that is different from the first location in the three-dimensional environment 303.

In FIG. 12, the first electronic device 101a displays the suggestion element 316 in front of the second user 301b from the viewpoint of the first electronic device 101a. In some examples, the first electronic device 101a displays the suggestion element 316 at a predetermined location relative to the third user 301c in the viewpoint of the first electronic device 101a, such as in front of, to the left of, to the right of, on, below, above, or at another predetermined location relative to the third user 301c from the current viewpoint of the first electronic device 101a.

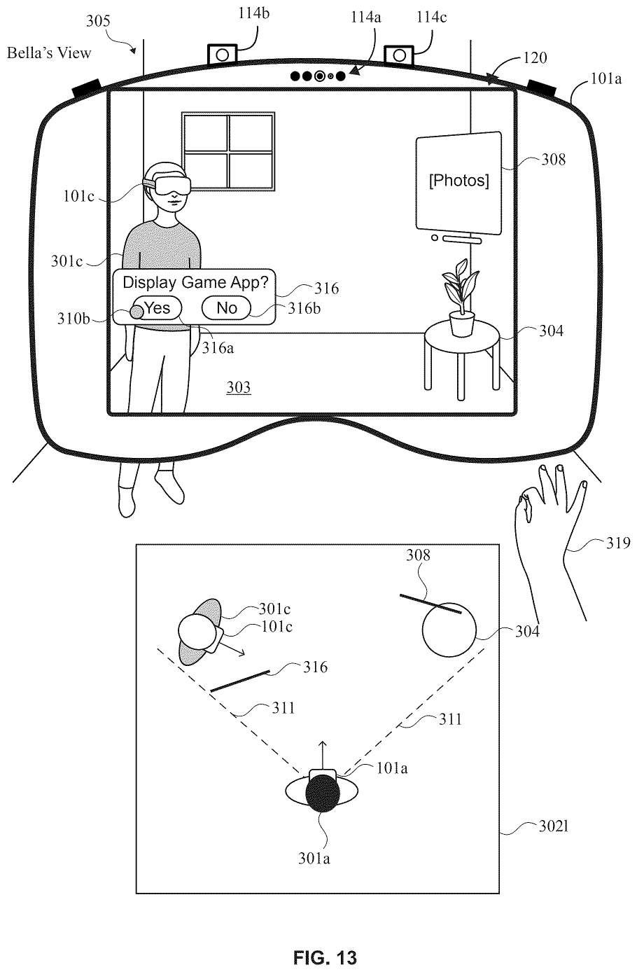

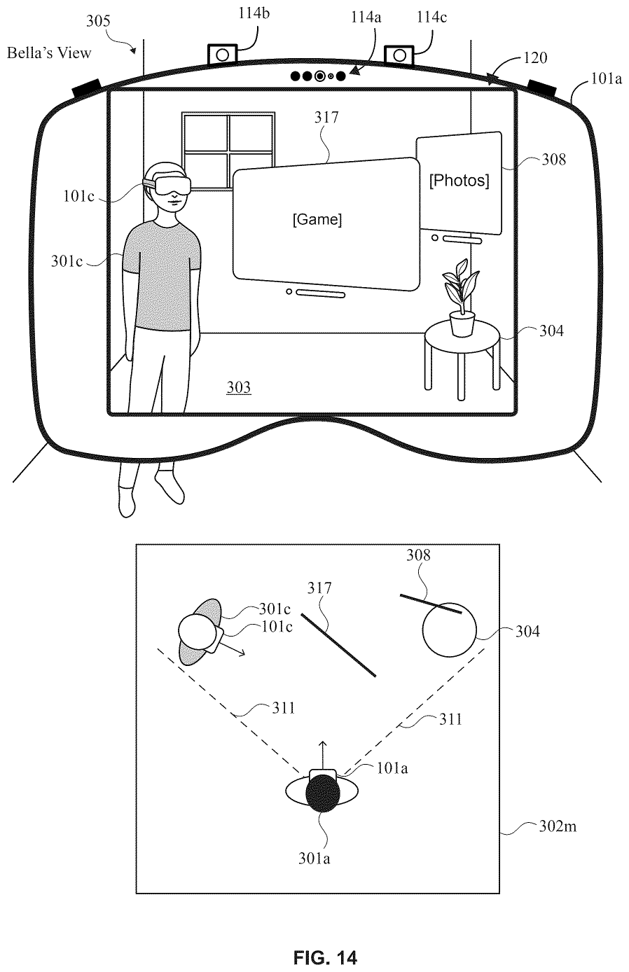

While presenting the view of the three-dimensional environment 303 shown in FIG. 12, the first electronic device 101a detects selection of the suggestion element 316, as shown in FIG. 13. For example, in FIG. 13, the first electronic device 101a optionally detects the hand 319 of the first user 301a performing an air pinch gesture directed to the option 316a of the suggestion element 316 (e.g., a tapping of the index finger with the thumb of the first user 301a) while attention (e.g., gaze) of the first user 301a is directed to the option 316a of the suggestion element 316, as shown with gaze point 310b. In some examples, the first electronic device 101a detects a gaze of the first user 301a and/or an air gesture directed to the suggestion element 316 in FIG. 13. Additionally or alternatively, the first electronic device 101a optionally detects a voice input, an input via a mouse, touch screen or trackpad, or another type of input described herein that is directed to the option 316a of the suggestion element 316. In response to detecting the selection in FIG. 13, the first electronic device 101a displays the user interface 317 of the gaming application, as shown in FIG. 14. FIG. 14 illustrates the first electronic device 101a displaying the user interface 317 of the gaming application in response to detecting the selection in FIG. 13. In some examples, in response to detecting the selection in FIG. 13, the first electronic device 101a also shares the user interface 317 of the gaming application with the third electronic device 101c, so that both the first user 301a of the first electronic device 101a and the third user 301c of the third electronic device 101c can experience the virtual content together via their respective electronic devices as described above, or otherwise causes the third electronic device 101c to be a part of the game shown in the user interface 317 of the gaming application.

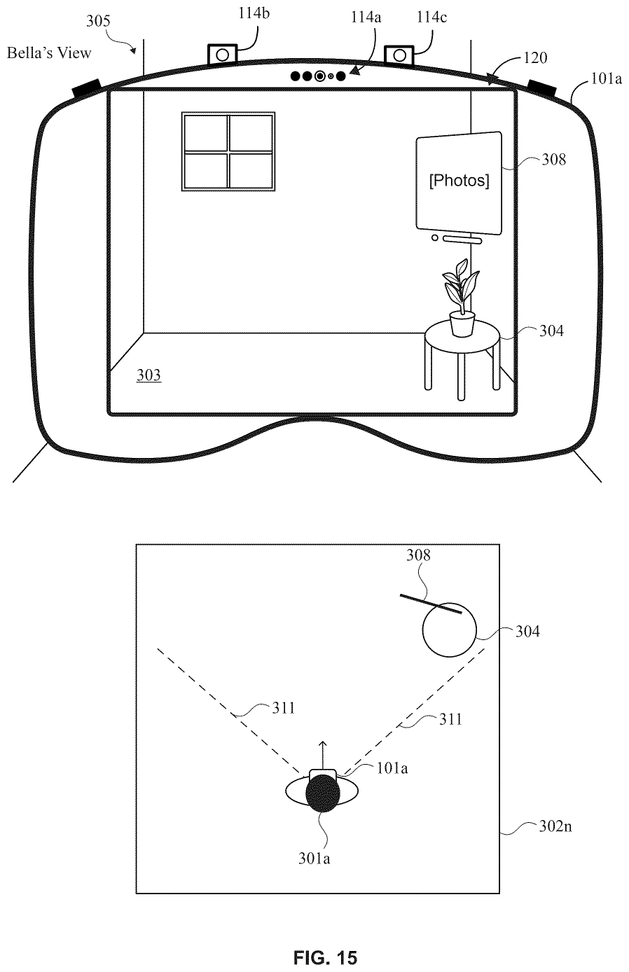

FIGS. 15 through 20 generally illustrate the first electronic device 101a associated with the first user detecting and responding to being collocated in the physical environment with the second user 301b of the second electronic device 101b and the third user 301c of the third electronic device 101c according to some examples of the disclosure. FIG. 15 illustrates the first electronic device 101a presenting a view of the three-dimensional environment 303 while in the physical environment 305, such as described with reference to FIG. 3 and/or FIG. 9.

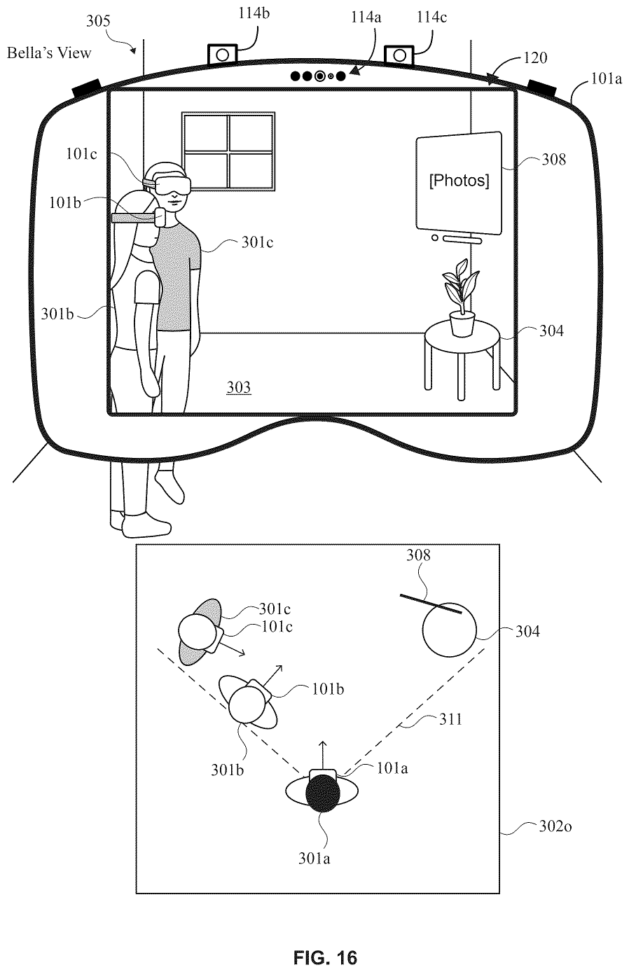

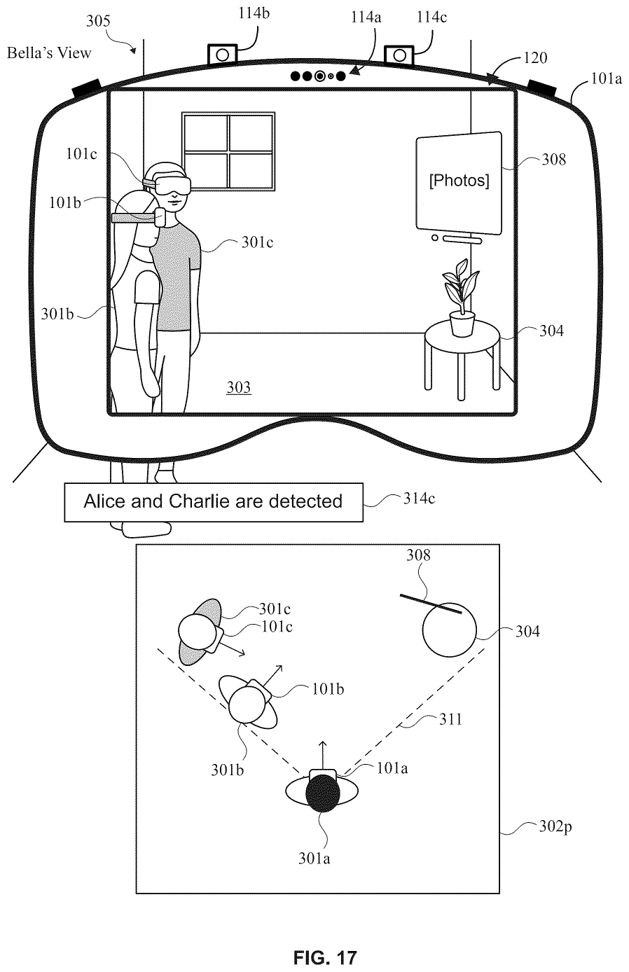

From FIG. 15 to FIG. 16, the second user 301b of the second electronic device 101b and the third user 301c of a third electronic device 101c enter the physical environment 305 in which the first electronic device 101a is located, and from FIG. 16 to FIG. 17, the first electronic device 101a detects that the first electronic device 101a is collocated in the physical environment 305 with the second electronic device 101b and the third electronic device 101c, such as shown in FIG. 17. In FIG. 17, as shown with notice 314c, which is representatively provided (e.g., is not necessarily displayed by the first electronic device 101a), the first electronic device 101a senses that it is collocated in the physical environment 305 with the specific user of the second electronic device 101b, namely second user 301b (e.g., “Alice”), and the specific user of the third electronic device 101c, namely third user 301c (e.g., “Charlie”).

In some examples, the second user 301b of the second electronic device 101b enters the physical environment 305 before the third user 301c. In some examples, were the second user 301b of the second electronic device 101b to enter the physical environment 305 before the third user 301c, the first electronic device 101a may detect that the first electronic device 101a and the second electronic device 101b are collocated in the physical environment 305 before detecting that the first electronic device 101a and third electronic device 101c are collocated in the physical environment 305. In some examples, the third user 301c of the third electronic device enters the physical environment 305 before the second user 301b. In some examples, were the third user 301c of the third electronic device to enter the physical environment 305 before the second user 301b, the first electronic device 101a would detect that the first electronic device 101a and third electronic device 101c are collocated in the physical environment 305 before detecting that the first electronic device 101a and the second electronic device 101b are collocated in the physical environment 305.

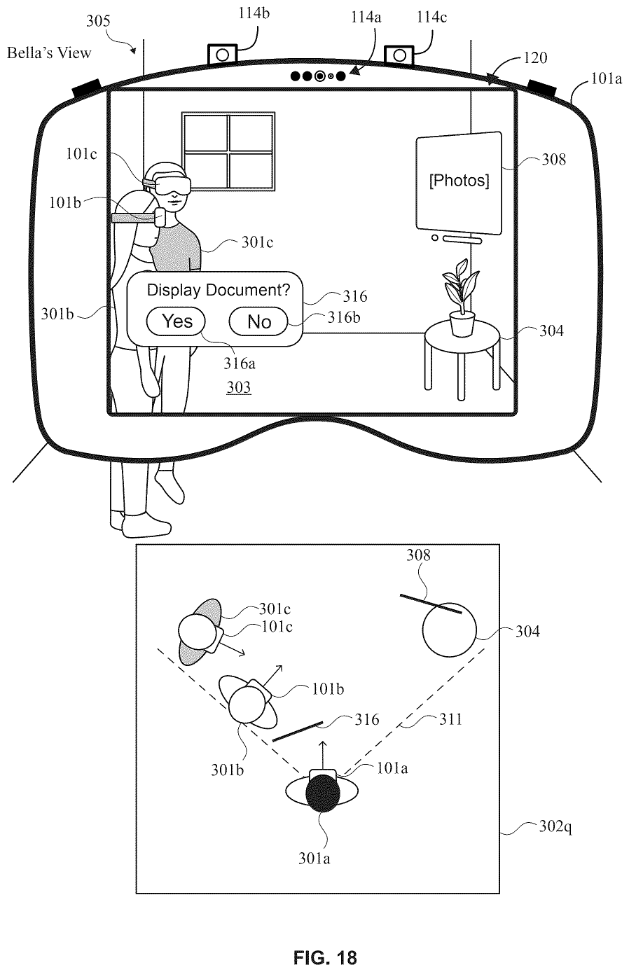

In some examples, the first user 301a of the first electronic device 101a, the second user 301b of the second electronic device 101b, and the third user 301c of the third electronic device 101c previously interacted with each other. For example, the first user 301a of the first electronic device 101a, the second user 301b of the second electronic device 101b, and the third user 301c of the third electronic device 101c may have played a virtual game together, been a part of a group email thread, a group text messaging conversation, a three-way call, and/or a video call session, or have otherwise previously shared content with each other, whether when previously collocated with each other or otherwise group together (e.g., in a three-way call). As another example, the first user 301a of the first electronic device 101a, the second user 301b of the second electronic device 101b, and the third user 301c of the third electronic device 101c may have interacted with an application while previously collocated in a physical environment (e.g., the physical environment 305 or another physical environment). In some examples, the first electronic device 101a senses the type(s) of previously interactions between the first user 301a of the first electronic device 101a, the second user 301b of the second electronic device 101b, and the third user 301c of the third electronic device 101c. For example, the first electronic device 101a optionally senses which applications (e.g., gaming applications, calling application, an Internet application, and/or other applications) were previously used between the first user 301a of the first electronic device 101a, the second user 301b of the second electronic device 101b, and the third user 301c of the third electronic device 101c. In some examples, in response to detecting that the first electronic device 101a is collocated in the physical environment 305 with the second electronic device 101b and the third electronic device 101c, the first electronic device 101a displays one or more suggestions that are contextualized to the second user 301b and the third user 301c (e.g., and optionally are based on those previous interactions between the first user 301a, the second user 102, and the third user 301c), such as shown from FIG. 17 to FIG. 18.

In some examples, the suggestion element 316 of FIG. 18 is selectable to display a user interface of an application that was previously shared or used between the first user 301a, the second user 102, and the third user 301c. In some examples, the suggestion element 316 of FIG. 18 is selectable to display a user interface of an application that was previously shared or used between the first user 301a, the second user 102, and the third user 301c when they were previously collocated in a physical environment. For example, in the illustrated example of FIG. 18, the suggestion element 316 is selectable to display a user interface (e.g., a word document user interface) of a word processing application optionally because the word processing application was previously shared or used between the first user 301a, the second user 102, and the third user 301c when the first user 301a, the second user 102, and the third user 301c were previously collocated in a physical environment. In some examples, were the first user 301a, the second user 102, and the third user 301c to have previously interacted with multiple applications, the first electronic device 101a displays a respective suggestion element for each application that they have previously interacted with, optionally with an order of priority in a list that is based on an amount of previous usage and/or how recent the interaction/usage was. In some examples, were the first user 301a, the second user 102, and the third user 301c to have previously interacted with multiple applications, the first electronic device 101a displays a respective suggestion element for each application up to two, three, or four, or another number of applications. In some examples, were the first user 301a, the second user 301b, and the third user 301c to have previously interacted with multiple applications, the first electronic device 101a displays a suggestion element for just the most recently used application between the first user 301a, the second user 301b, and the third user 301c. In FIG. 18, the suggestion element 316 is illustrated as being selectable to display a word document of a word processing application optionally because the first user 301a, the second user 301b, and the third user 301c are collaborators of the word document and/or because the first user 301a, the second user 301b, and the third user 301c have previously used or interacted with the word document when they were previously collocated in a physical environment.

In some examples, the first electronic device 101a displays the suggestion element 316 in FIG. 18 at a location in the three-dimensional environment 303 that is based on a spatial arrangement between the current viewpoint of the first electronic device 101a and the second user 301b and the third user 301c. In some examples, were the spatial arrangement between the current viewpoint of the first electronic device 101a and the second user 301b and the third user 301c a first spatial arrangement, the first electronic device 101a would optionally display the suggestion element 316 at a first location in the three-dimensional environment 303. In some examples, were the spatial arrangement between the current viewpoint of the first electronic device 101a and the second user 102 and the third user 301c a second spatial arrangement that is different from the first spatial arrangement, the first electronic device 101a would display the suggestion element 316 at a second location in the three-dimensional environment 303 that is different from the first location in the three-dimensional environment 303. In some examples, the location of display of the suggestion element 316 is in between the second user 301b and the third user 301c in the viewpoint of the first electronic device 101a, and/or is at a location that is at or near (e.g., in front of) a midpoint position between the second user 301b and the third user 301c from the viewpoint of the first electronic device 101a.

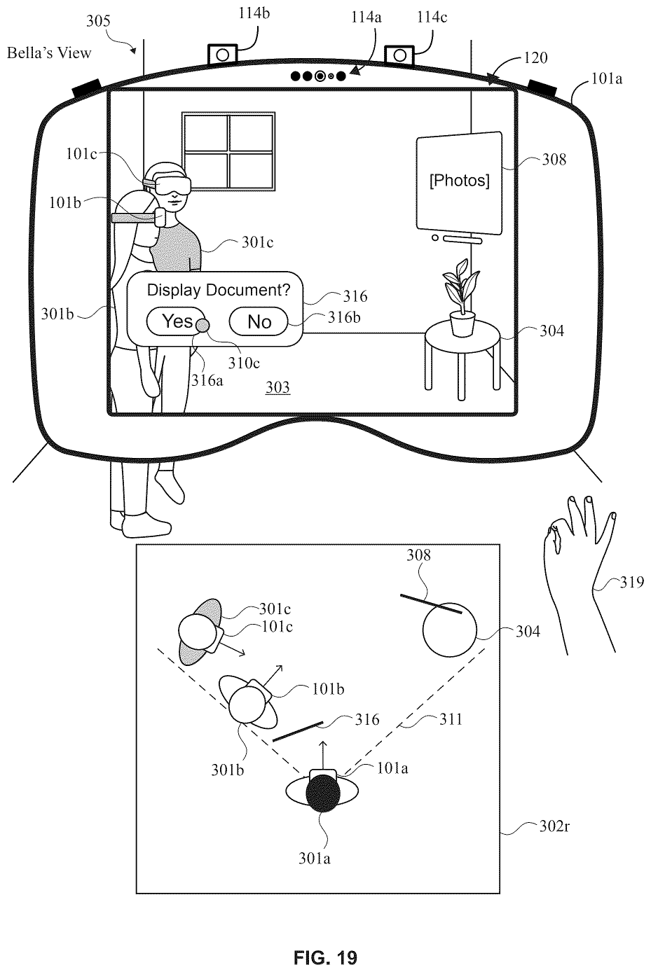

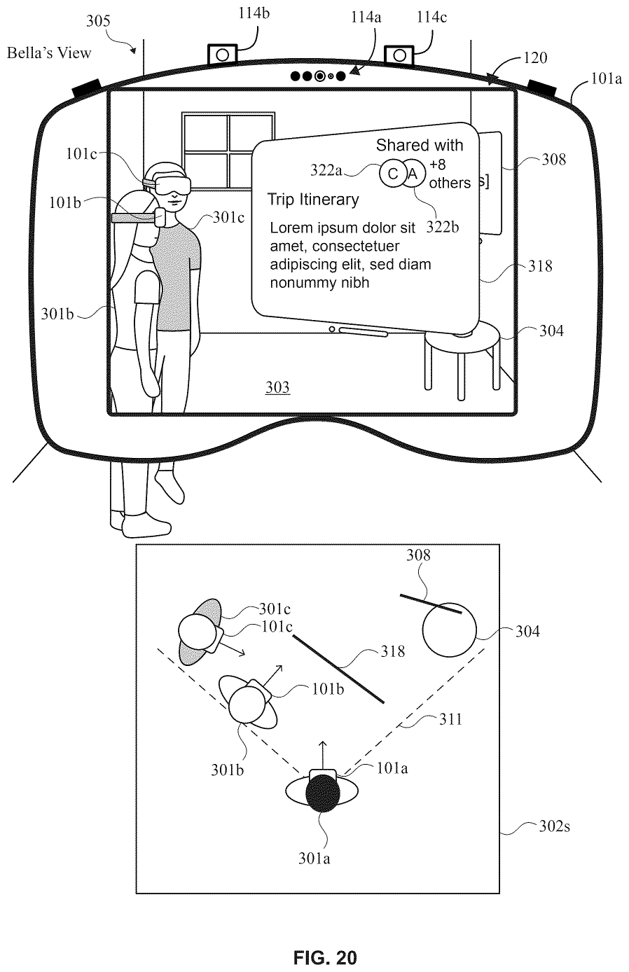

While presenting the view of the three-dimensional environment 303 shown in FIG. 18, the first electronic device 101a detects selection of the suggestion element 316, as shown in FIG. 19. For example, in FIG. 19, the first electronic device 101a optionally detects the hand 319 of the first user 301a performing an air pinch gesture directed to the option 316a of the suggestion element 316 (e.g., a tapping of the index finger with the thumb of the first user 301a) while attention (e.g., gaze) of the first user 301a is directed to the option 316a of the suggestion element 316, as shown with gaze point 310c. In some examples, the first electronic device 101a detects a gaze of the first user 301a and/or an air gesture directed to the option 316a of the suggestion element 316 in FIG. 19. Additionally or alternatively, the first electronic device 101a optionally detects a voice input, an input via a mouse, touch screen or trackpad, or another type of input described herein that is directed to the option 316a of the suggestion element 316. In response to detecting the selection in FIG. 19, the first electronic device 101a displays a user interface 318 of word processing application, as shown in FIG. 20. FIG. 20 illustrates the first electronic device 101a displaying the user interface 318 of the word processing application in response to detection of the selection in FIG. 19. In some examples, in response to detecting the selection in FIG. 19, the first electronic device 101a also shares the user interface 318 of the word processing application with the second electronic device 101b and the third electronic device 101c, so that all of the first user 301a of the first electronic device 101a, the second user 301b of the second electronic device 101b, and the third user 301c of the third electronic device 101c can experience the virtual content together via their respective electronic devices as described above (e.g., with reference to FIGS. 8A and 8B).

FIGS. 20 through 30 generally illustrate the first electronic device 101a causing the word application to perform different operations based on who is collocated in the physical environment 305 with the first user 301a of the first electronic device 101a according to some examples of the disclosure.

In FIG. 20, the first electronic device 101a is displaying the user interface 318 of the word processing application showing a word document. A set of persons, including the first user 301a, second user 301b, the third user 301c, and eight other persons have access to the word document (e.g., are collaborators, editors, or otherwise have access to view the word document). In FIG. 20, the first user 301a of the first electronic device 101a is collocated with the second user 301b and the third user 301c. In FIG. 20, the user interface 318 also indicates with whom the word document is shared. In FIG. 20, the user interface 318 includes indications of persons who have access to the word document, and the first electronic device 101a causes the user interface 318 to order the indications of collaborators of the word document in accordance with whether a respective collaborator is currently collocated in the physical environment 305 with the first user 301a. For instance, were a respective collaborator of the word document to not be collocated in the physical environment 305 with the first user 301a, the respective collaborator would optionally occupy a lower position in the listing of collaborators. Continuing with this instance, were the respective collaborator of the word document to be collocated in the physical environment 305 with the first user 301a, the respective collaborator would optionally occupy a higher position in the listing of collaborators of the word document.

In FIG. 20, the order of priority with which the indications of collaborators of the word document is displayed includes the second user 301b and the third user 301c occupying the first and second positions in the ordering optionally because the second user 301b and the third user 301c are collocated in the physical environment 305 with the first user 301a of the first electronic device 101a. For example, in FIG. 20, the first element 322a (e.g., an icon, a photo, or another element representative of the third user 301c), which specifically indicates that the third user 301c (“Charlie”) is a collaborator in the word document, is at a first position in the ordering, and the second element 322b, which specifically indicates that the second user 301b is a collaborator in the word document, is at a second position in the ordering. The user interface 318 may also display respective elements for the remaining eight persons with whom the word document is shared at lower positions then the first and second positions because the first and second positions are currently occupied by collaborators that are collocated in the physical environment 305 with the first user 301a. For example, in FIG. 20, were all the collaborators of the word document to be displayed in the user interface 318, the order with which the collaborators would be displayed would be based on whether the collaborator is currently collocated with the first user 301a in the physical environment 305.

In some examples, indications of collaborators have different appearances based on whether the collaborator is collocated in the physical environment 305 with the first user 301a. For example, were a respective collaborator to be collocated in the physical environment 305 with the first user 301a, the first electronic device 101a would optionally cause the user interface 318 it displays to have an indication of the respective collaborator that has a first visual appearance. Continuing with this example, were the respective collaborator to not be collocated in the physical environment 305 with the first user 301a, the first electronic device 101a would optionally cause the user interface 318 it displays to have an indication of the respective collaborator that has a second visual appearance that is different from the first visual appearance.

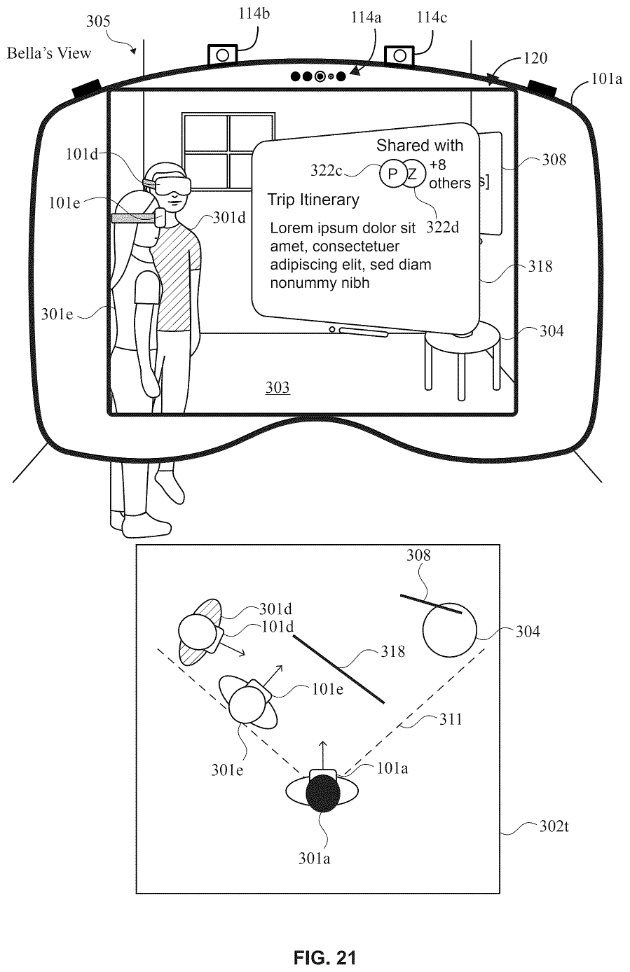

FIG. 21 shows an alternative example of the first user 301a of the first electronic device 101a being collocated with a different set of users of electronic devices in the physical environment 305 with whom the word document is shared, and in response, the first electronic device 101a causes the word document to order the indications of collaborators of the word document in accordance with whether a respective collaborator is currently collocated in the physical environment 305 with the first user 301a. For example, in FIG. 21, the first user 301a of the first electronic device 101a is not collocated with the second user 301b and the third user 301c as in FIG. 20, but instead is collocated in the physical environment 305 with a fourth user 301d of a fourth electronic device 101d and a fifth user 301e of a fifth electronic device 101e, both of whom are collaborators in the same word document as in FIG. 20. In FIG. 21, the user interface 318 orders (e.g., the first electronic device 101a causes the user interface 318 to order) the indications of collaborators of the word document in accordance with whether a collaborator is currently collocated in the physical environment 305 with the first user 301a. In FIG. 21, the first user 301a is collocated in the physical environment 305 with the fourth user 301d of the fourth electronic device 101d and the fifth user 301e of the fifth electronic device 101e. In FIG. 21, the order of priority with which the indications of collaborators of the word document are displayed includes the fourth user 301d and the fifth user 301e occupying the first and second positions in the ordering, respectively. For example, in FIG. 21, the third element 322c (e.g., an icon, a photo, or another element representative of the fourth user 301d), which specifically indicates that the fourth user 301d (“Paul”) is a collaborator in the word document, is at the first position in the ordering, and the fourth element 322d, which specifically indicates that the fifth user 301e (“Zoe”) is a collaborator in the word document, is at the second position in the ordering. The user interface 318 may also display respective elements for the remaining eight persons with whom the word document is shared at lower positions than the first and second positions because the first and second positions are currently occupied by collaborators that are collocated in the physical environment 305 with the first user 301a in FIG. 21. For example, were all the collaborators of the word document in FIG. 21 to be displayed in the user interface 318, the order with which the collaborators would be displayed would be based on whether the collaborator is currently collocated with the first user 301a in the physical environment 305, such as described with reference to FIG. 20.

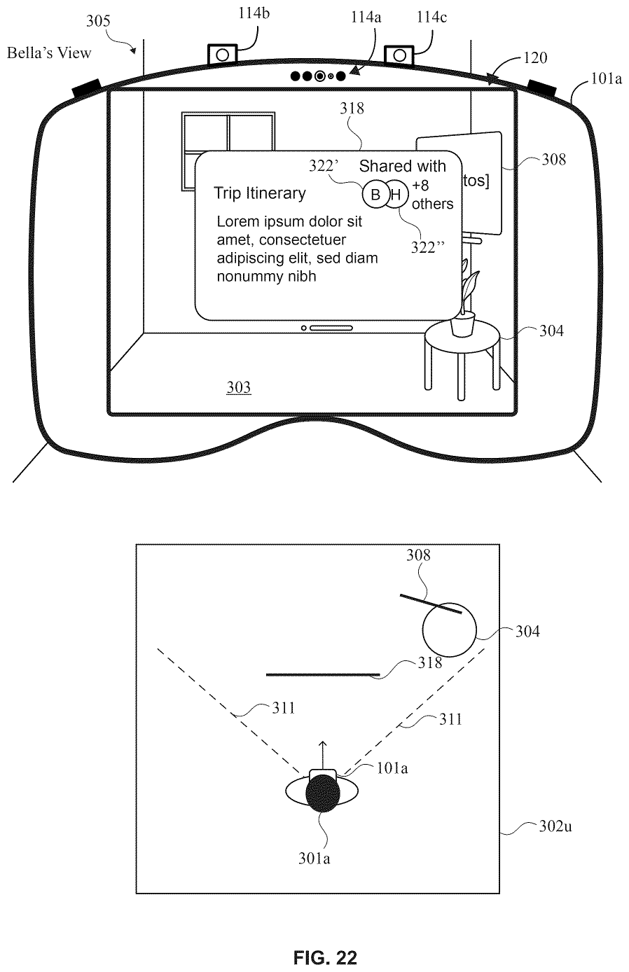

FIG. 22 shows another alternative example of the first user 301a of the first electronic device 101a not being collocated with any users of electronic devices in the physical environment 305 with whom the word document is shared, and in response, the word document listing (e.g., the first electronic device 101a causes the word document to order the list of) those with whom the word document is shared in a random order (e.g., defaulting to randomizing the order or defaulting to not considering a status of collocation when listing with whom the word document is shared). For example, the first respective element 322′ and the second respective element 322″ optionally correspond to two different users with whom the word document is shared, and the order of them in the full list of users with whom the word document is shared is optionally randomized and/or does not consider a status of collocation. As such, in some examples, the first electronic device 101a may cause applications to perform different operations based on who is collocated in the physical environment with the first user 301a of the first electronic device 101a.

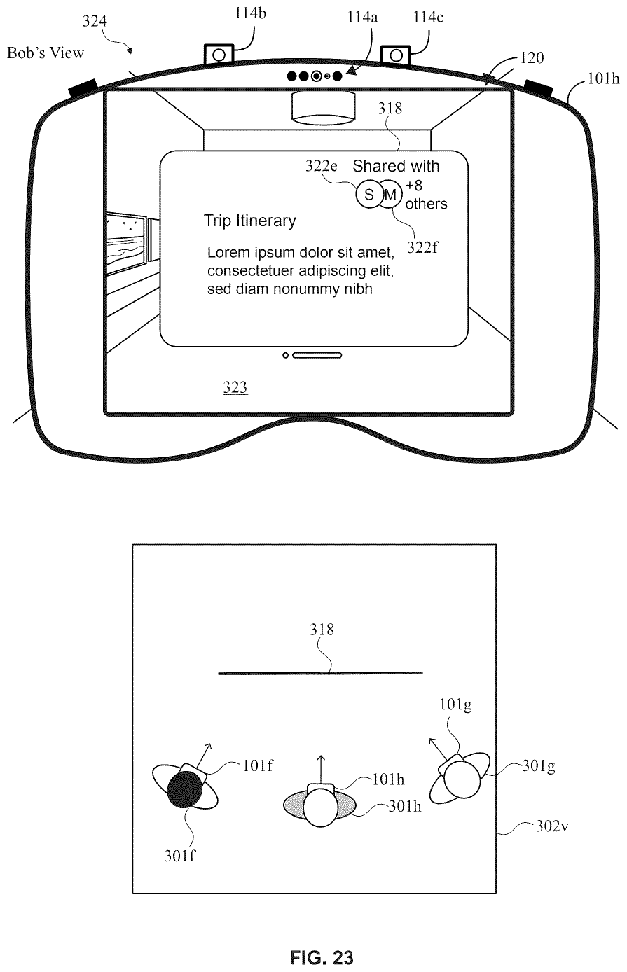

Additionally, note that were the first user 301a, the second user 301b, and the third user 301c collocated in the physical environment 305 as in FIG. 20, and were there were a set of persons with whom the word document is also shared collocated in another physical environment, such as a sixth user of a sixth electronic device and seventh user of a seventh electronic device in the other physical environment, and were the word document displayed in both settings, the word document would optionally order (e.g., the respective electronic device that displays the word document would optionally cause the word document to order) the indications of collaborators of the word document in accordance with whether a respective collaborator is currently collocated in their respective physical environment, such as shown in FIGS. 20 and 23. In FIG. 20, the first electronic device 101a causes the user interface 318 to order the indications of collaborators of the word document in accordance with whether a collaborator is currently collocated in the physical environment 305 with the first user 301a, such as described above with reference to FIG. 20, and as such, the user interface 318 shows the second user 301b and the third user 301c (even though the word document is also shared with other users including the fourth user, the fifth user, and a sixth user) occupying the two highest positions in the listing because just the second user 301b and the third user 301c are collocated in the physical environment 305 with the first user 301a of the first electronic device 101a. In FIG. 23, which shows a view of a three-dimensional environment 323 that is visible via a display 120 of an eighth user 301h of an eighth electronic device 101h (that is in a physical environment 324 that is different from the physical environment 305) with whom the word document is shared, the eighth electronic device 101h causes the user interface 318 of the word processing application to order the indications of collaborators of the word document in accordance with whether a collaborator is currently collocated in the physical environment 324 with the eighth user 301h, and as such the user interface 318 of FIG. 23 shows the sixth user 301f and the seventh user 301g occupying the two highest positions in the listing (by manner of the position of the fifth element 322e corresponding to the sixth user 301f and the position of the sixth element 322f corresponding to the seventh user 301g in the listing), even though the word document is also shared with other users including the first user 301a, the second user 301b, and the third user 301c, because the sixth user 301f and the seventh user 301g are collocated in the physical environment 324 with the eighth user 301h of the eighth electronic device 101h in FIG. 23.

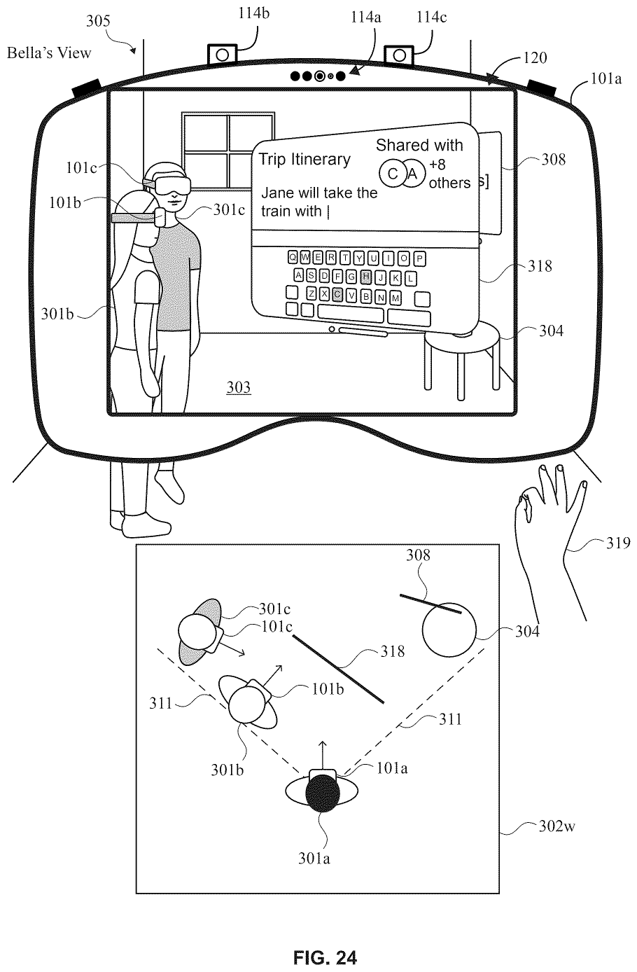

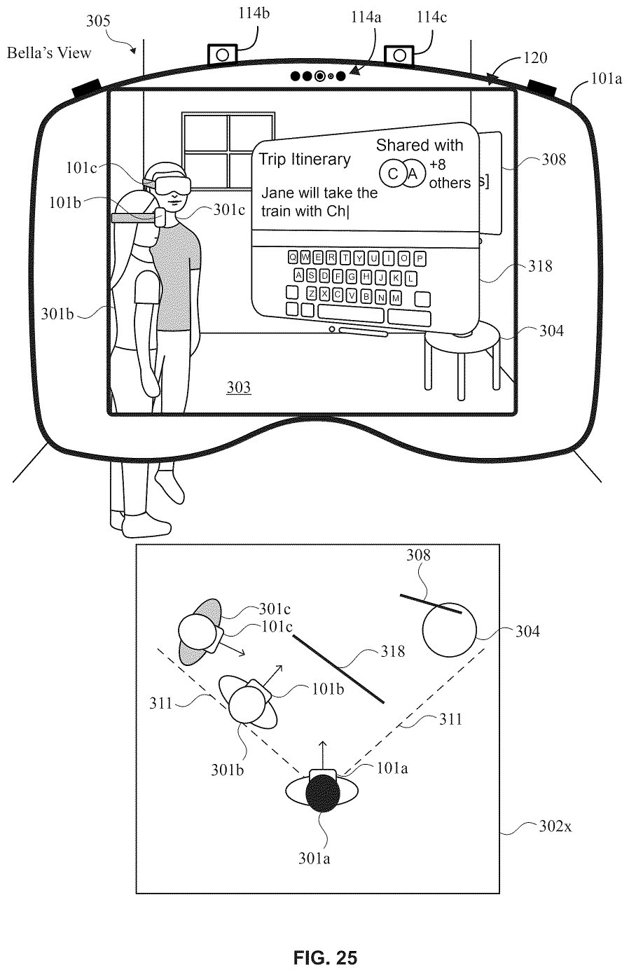

Returning back to FIG. 20, in which the first electronic device 101a is collocated in the physical environment 305 with the second electronic device 101b and third electronic device 101c, while presenting the view of the three-dimensional environment 303 shown in FIG. 20, the first electronic device 101a detects input into a text entry field of the word document, as shown from FIG. 20 to FIG. 24. For example, in FIG. 24, the first electronic device 101a optionally detects the hand 319 of the first user 301a performing an air pinch gesture directed to the keys of a keyboard (e.g., to a “C” key and then to an “H” key) while attention (e.g., gaze) of the first user 301a is directed to the keyboard. Additionally or alternatively, the first electronic device 101a optionally detects a voice input, an input via a mouse, touch screen or trackpad, or another type of input described herein that is directed to the keyboard. In response to the typing input of FIG. 24, the first electronic device 101a updates display of the word document user interface to include the letters that the first user 301a has typed, such as shown in FIG. 25. Thus, the input of FIG. 24 includes the first user 301a typing the letters “Ch”, and the first electronic device 101a updates display of the word document user interface to include those letters, as shown in FIG. 25.

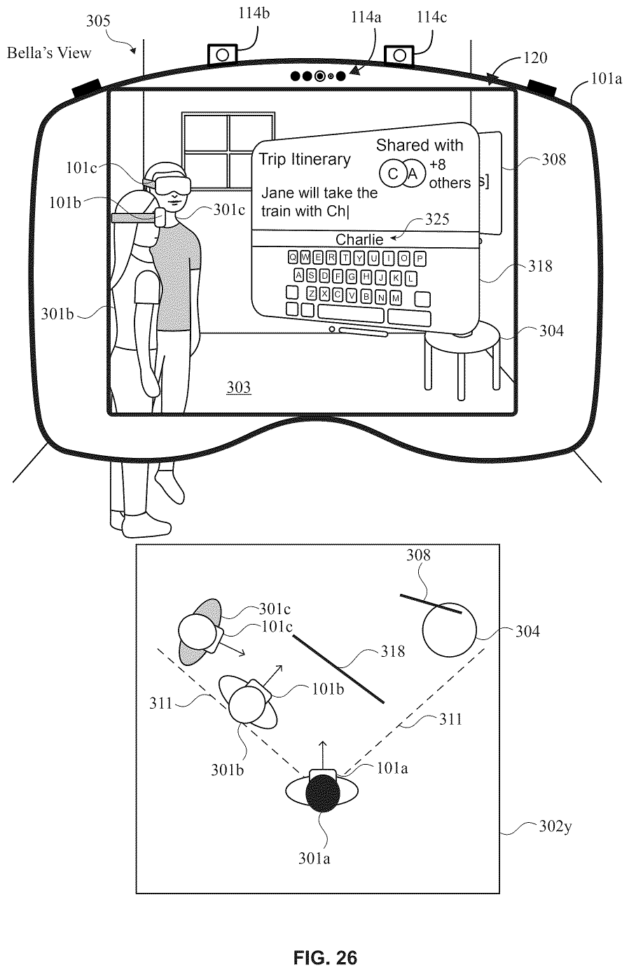

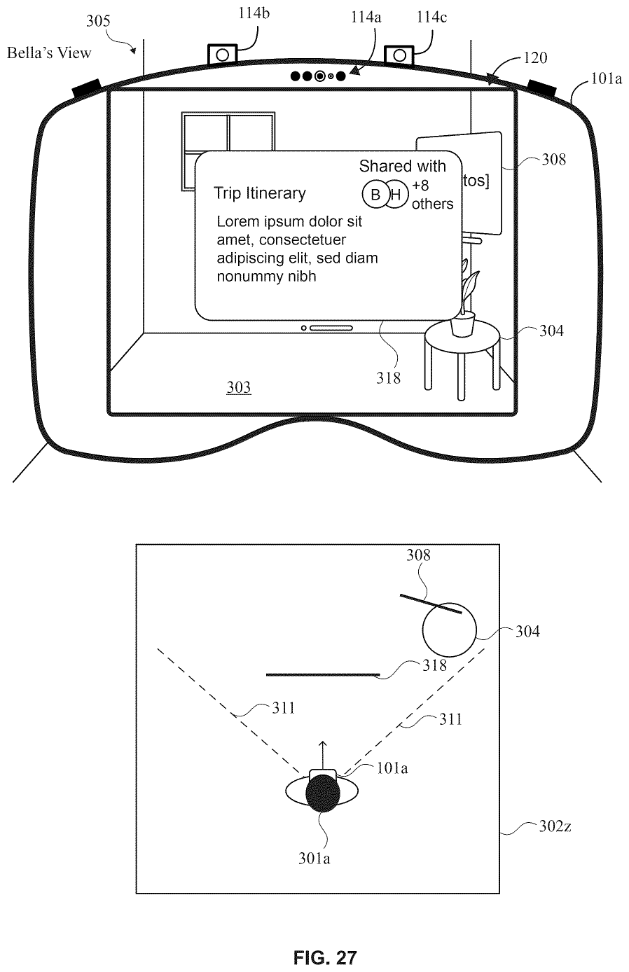

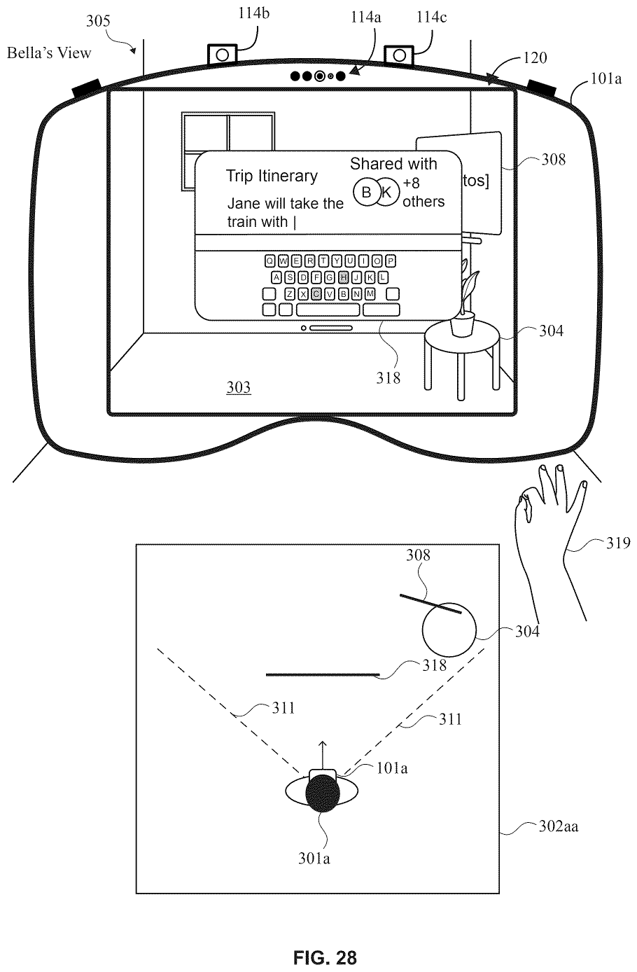

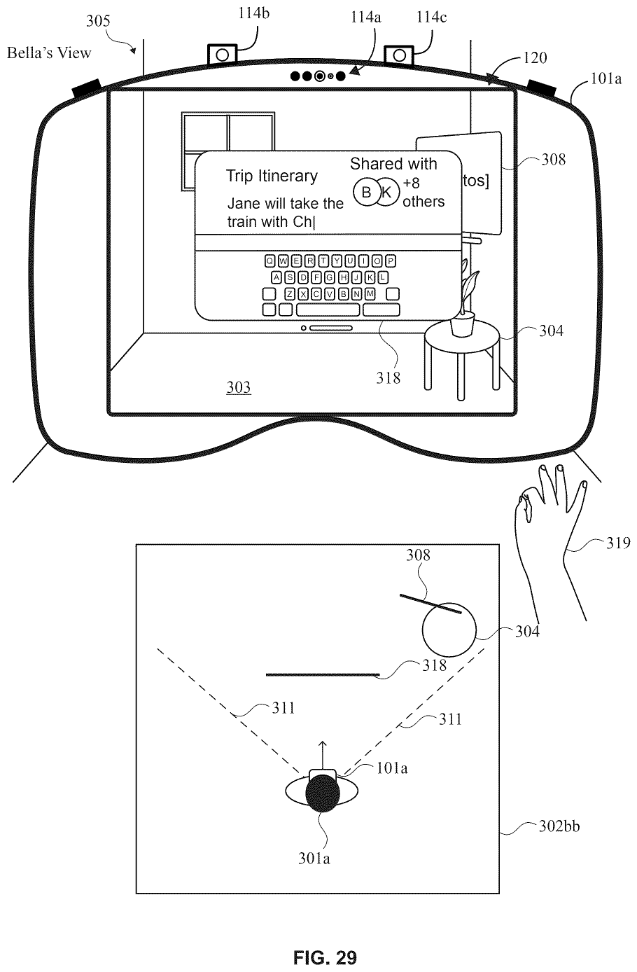

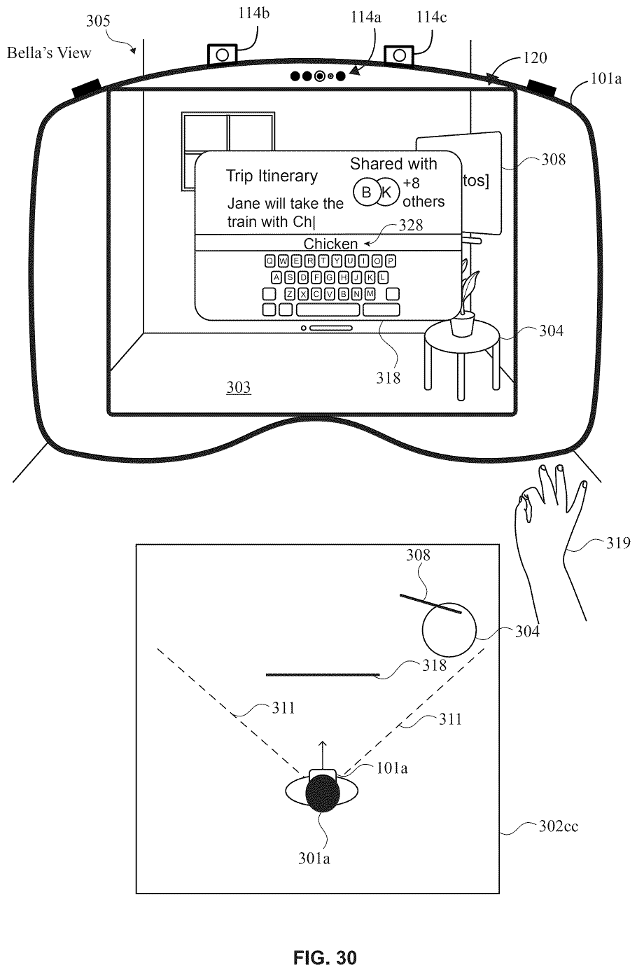

In addition, the word processing application suggests (e.g., the first electronic device 101a causes the word processing application to suggest) a word to complete the word that has the letters that the first user 301a has typed, such as shown from FIG. 25 to FIG. 26. In some examples, the suggestions made by the word processing application are based on the set of users that are collocated in the physical environment 305 with the first user 301a. For example, from FIG. 25 to FIG. 26, the word processing application suggests the word “Charlie”, which is the first word 325 in FIG. 26, to complete the word that has the letters that the first user 301a has typed (e.g., the first electronic device 101a causes the word processing application to suggest the word “Charlie”). In some examples, the word “Charlie” is suggested by the word processing application because the word processing application is aware that the first user 301a of the first electronic device 101a is concurrently collocated with the third electronic device 101c, which is being used by the third user 301c, who is Charlie. For example, the first electronic device 101a optionally transmits, to the word processing application, data that indicates that the first electronic device 101a is collocated with the third user 301c of the third electronic device 101c. As another example, were the first electronic device 101a not collocated in the physical environment 305 with Charlie (e.g., the third user 301c of the third electronic device 102c), and the first electronic device 101a to detect the input of FIG. 22 (e.g., to detect “Ch”), the first electronic device 101a would optionally suggest another word to complete the word that has the letters that the first user 301a has typed, such as shown from FIG. 27 to FIG. 28 to FIG. 29 to FIG. 30. In FIG. 27, the first electronic device 101a is not collocated in the physical environment 305 with the third user 301c. From FIG. 27 to FIG. 28, the first electronic device 101a detects the same typing input as in FIG. 22, from FIG. 28 to FIG. 29, the first electronic device 101a updates display of the word document to include the requested letters, and from FIG. 29 to FIG. 30, the first electronic device 101a suggests a word to complete the word that has the letters that the first user 301a has typed (e.g., the letters “Ch”). In FIG. 30, the word processing application suggests the word “Chicken”, which is the second word 328 in FIG. 30, to complete the word that has the letters that the first user 301a has typed and not “Charlie” because in FIG. 30 the first electronic device 101a is not collocated in the physical environment 305 with Charlie (e.g., the third user 301c of the third electronic device 101c) and further is optionally not collocated in the physical environment 305 with any other user that has a name or other identifier starting with “Ch”.

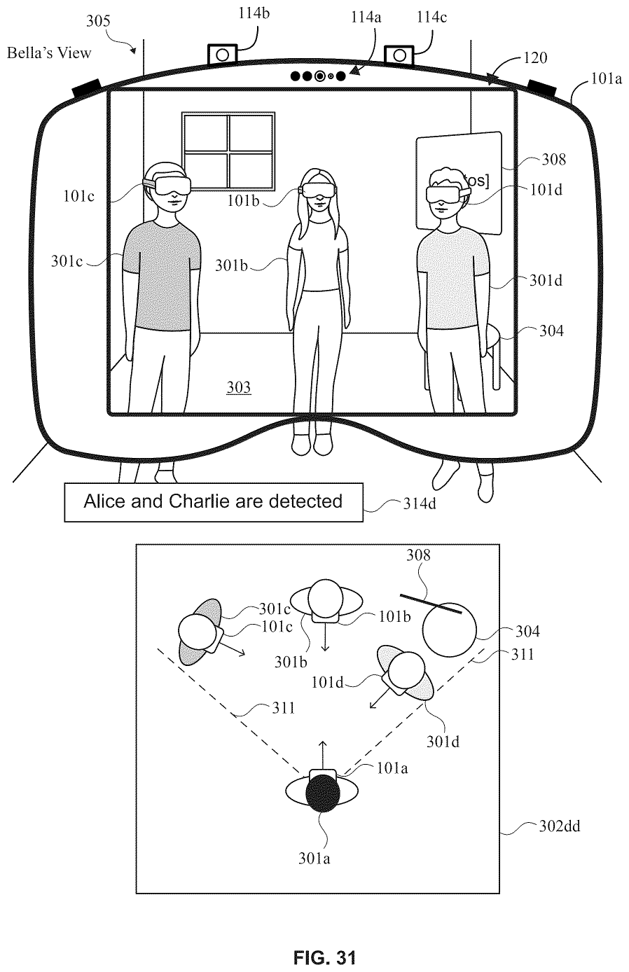

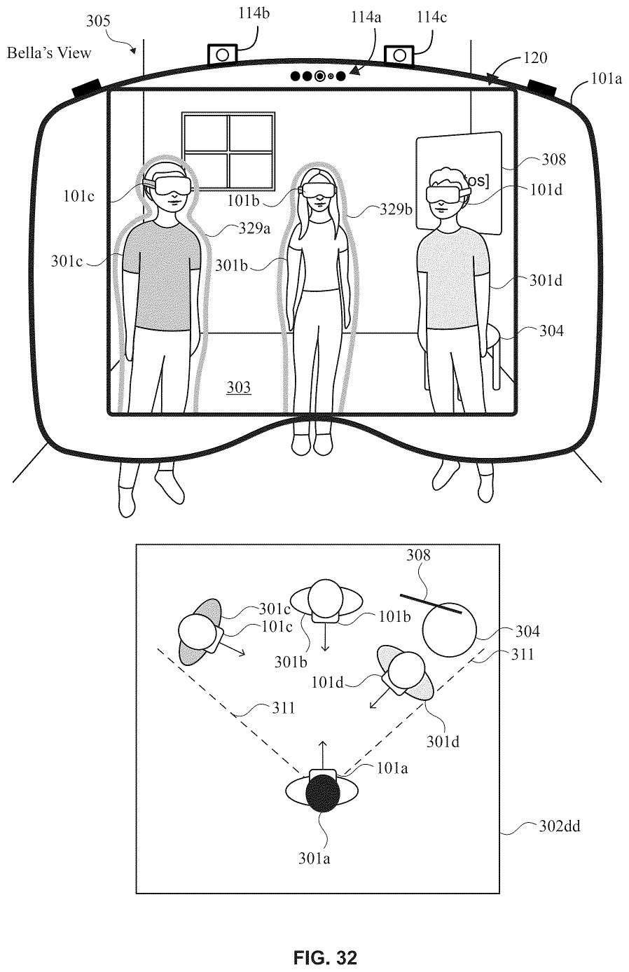

FIGS. 31 and 32 generally illustrate another example of the first electronic device 101a visually emphasizing the set of users of electronic devices with whom the first user 301a of the first electronic device 101a is collocated in the physical environment 305, according to some examples of the disclosure.

In FIG. 31, though three users of electronic devices are present in the physical environment 305 in which the first electronic device 101a is located, the first electronic device 101a detects that the first electronic device 101a is collocated in the physical environment 305 with the second electronic device 101b and the third electronic device 101c, as shown with notice 314d, and is not collocated in the physical environment 305 with the fourth user 301d of the fourth electronic device 101d. For example, though the fourth user 301d of the fourth electronic device 101d is in the physical environment 305, the first user 301a and the fourth user 301d may have not previously interacted with each other. For example, the fourth user 301d may not be in a contact list of an application on the first electronic device 101a. In response to detecting that that the first electronic device 101a is collocated in the physical environment 305 with the second electronic device 101b and the third electronic device 101c (e.g., in response to detecting that the first user 301a is collocated in the physical environment with the second user 301b and the third user 301c), the first electronic device 101a visually emphasizes (e.g., augments, increases in visual prominence, increases an apparent brightness of) the second user 301b, as shown with the glow 329b, and the third user 301c, as shown with the glow 329a, from the viewpoint of the first electronic device 101a, optionally allowing for more seamless interaction between the first user 301a and the second user 301b and the third user 301c in the physical environment 305. Additionally as shown in FIG. 32, the first electronic device 101a forgoes visually emphasizing the fourth user 301d because the first user 301a and the fourth user 301d are not collocated in the physical environment 305.

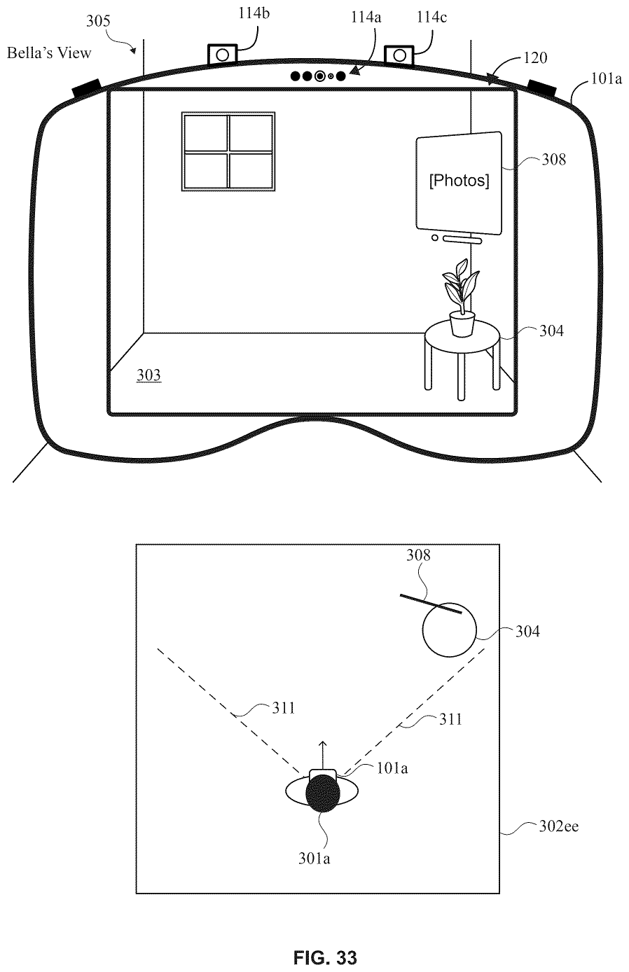

FIGS. 33 through 37 generally illustrate another example of the first electronic device 101a detecting and responding to being collocated in the physical environment with another user of another electronic device, according to some examples of the disclosure.

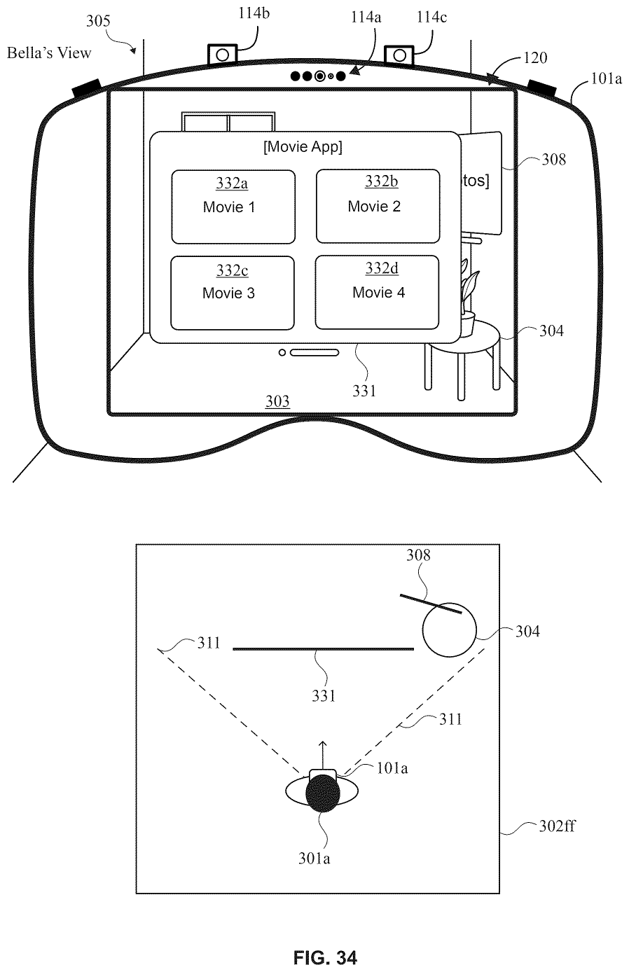

In FIG. 33, the first electronic device 101a is presenting a view of the three-dimensional environment 303 while in the physical environment 305, such as described with reference to FIGS. 3, 9, and/or 15. From FIG. 33 to FIG. 34, the first electronic device 101a displays a user interface 331 of a movie application (e.g., a content playback application). For example, while presenting the view of the three-dimensional environment 303 according to FIG. 33, the first electronic device 101a has optionally detected a user input requesting display of the user interface 331 of the movie application. In response, the first electronic device 101a displays the user interface 331 of the movie application as shown in FIG. 34.

In FIG. 34, the user interface 331 of the movie application includes a plurality of selectable options 332 that are optionally selectable to view information of and/or initiate playback of different movies (e.g., different content). For example, the first selectable option 332a is optionally selectable to view information corresponding to a first movie and/or initiate playback of the first movie; the second selectable option 332b is optionally selectable to view information corresponding to a second movie and/or initiate playback of the second movie; the third selectable option 332c is optionally selectable to view information corresponding to a third movie and/or initiate playback of the third movie; and the fourth selectable option 332d is optionally selectable to view information corresponding to a fourth movie and/or initiate playback of the fourth movie.

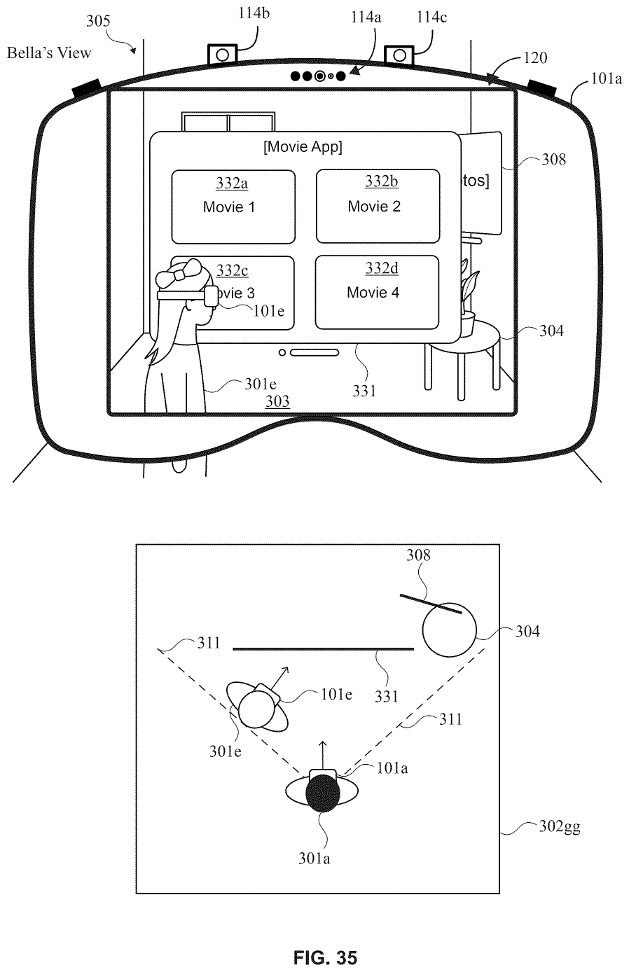

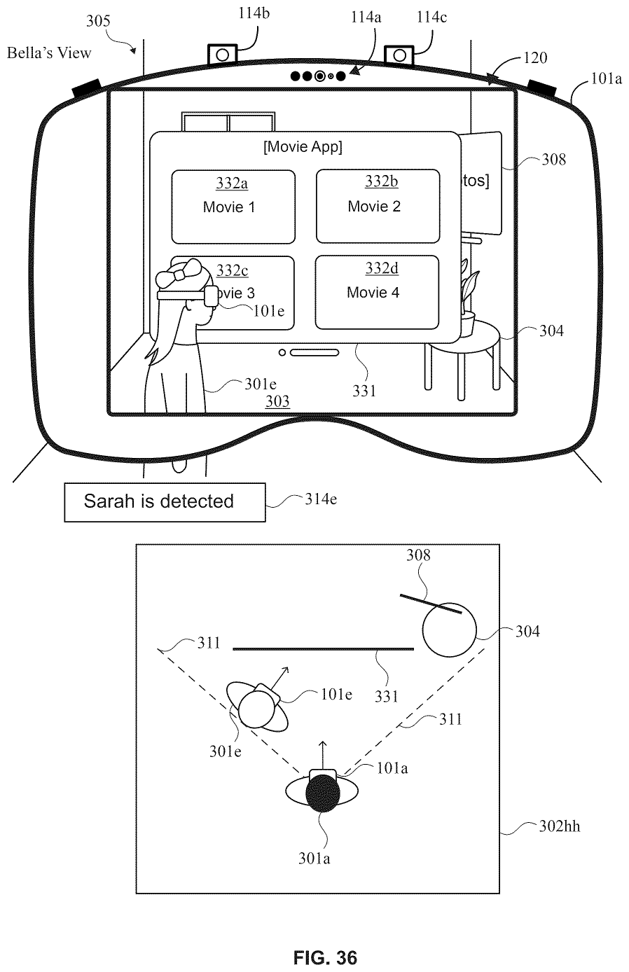

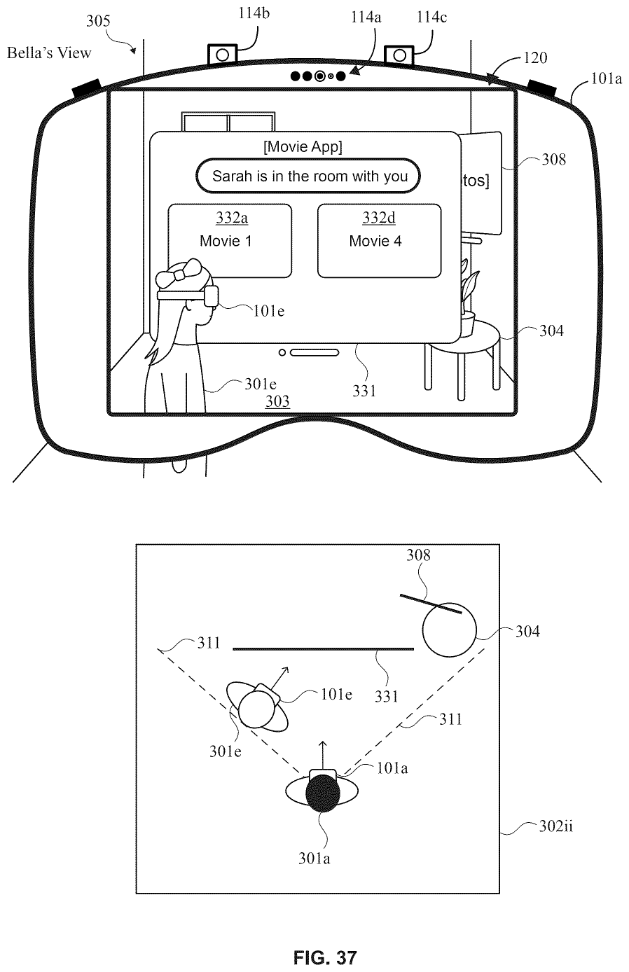

While displaying the view of the three-dimensional environment 303 illustrated in FIG. 34, a fifth user 301e of a fifth electronic device 101e enters the room in which the first user of 301a of the first electronic device 101a is located, as shown in FIG. 35. From FIG. 35 to FIG. 36, the first electronic device 101a detects that the first electronic device 101a is collocated in the physical environment 305 with the fifth electronic device 101e, as shown with the notice 314e. In response, the first electronic device 101a causes the movie application to change (e.g., reduce) the number of movies that are selectable for playback, as shown from FIG. 36 to FIG. 37. For example, the fifth user 301e may be a child (e.g., of ten years or younger), and in FIG. 34, the plurality of selectable options is optionally associated with mature content or content otherwise unsuitable for children (e.g., content rated PG-13 or above). In response to detecting that the first user 301a is collocated with the fifth user 301e, the first electronic device 101a causes the movie application to update which movies are available for playback and the update is optionally in accordance with the fifth user 301e being collocated with the first user 301a in the physical environment 305.

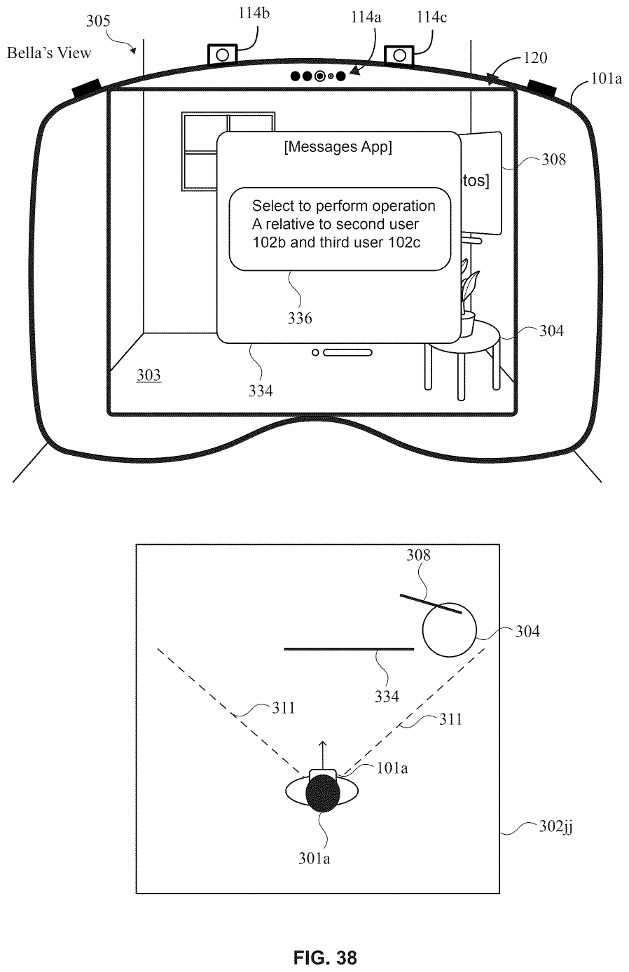

FIGS. 38 through 40 generally illustrate another example of the first electronic device 101a detecting and responding to being collocated in the physical environment with a set of users of electronic devices, according to some examples of the disclosure.

In FIG. 38, the first electronic device 101a is displaying a messaging user interface 334 of a message application. In FIG. 38, the messaging conversation includes an option 336 that is selectable to perform a first operation relative to the second user 301b and the third user 301c, such as being selectable to call and/or initiate a live communication between the first user 301a of the first electronic device 101a, the second user 301b of the second electronic device 101b, and the third user of the third electronic device. Note that in FIG. 38, the first user 301a of the first electronic device 101a is not collocated with the second user 301b and the third user 301c.

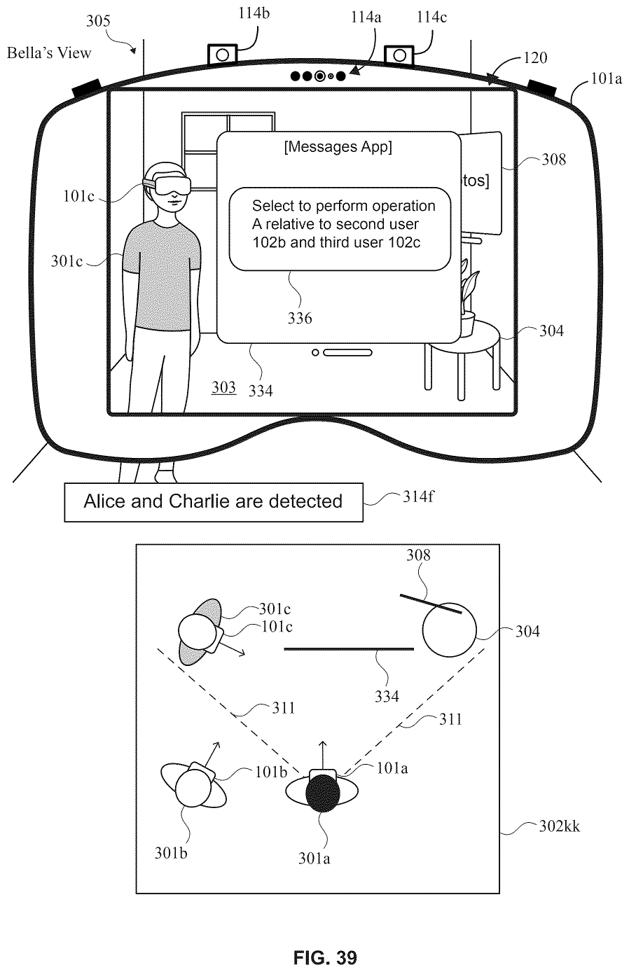

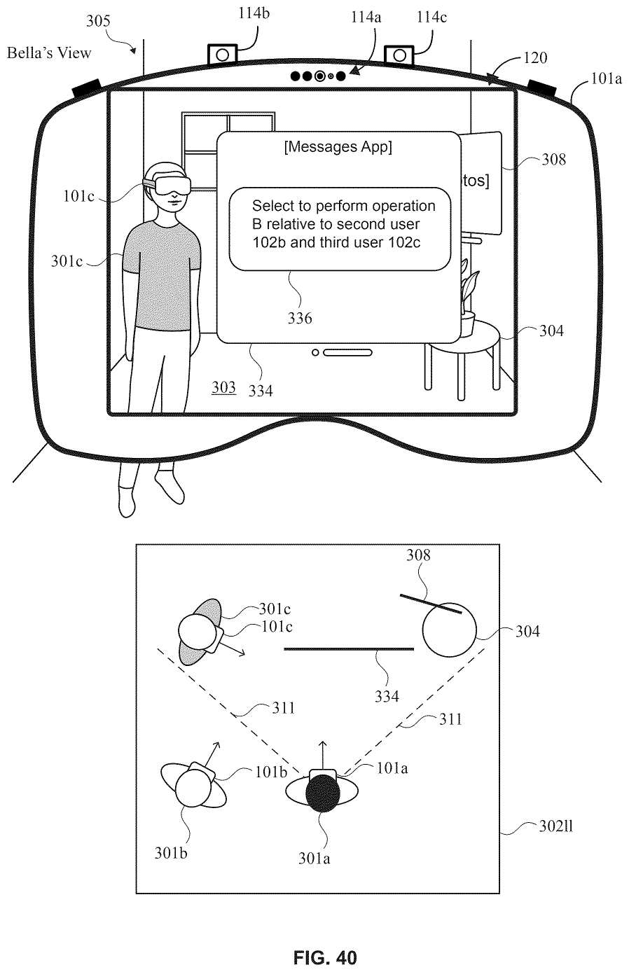

From FIG. 38 to FIG. 39, the second user 301b of the second electronic device 101b and the third user 301c enter the physical environment 305 in which the first user 301a of the first electronic device 101a is located, and the first electronic device 101a detects that the first user 301a is collocated with the second user 301b and the third user 301c in the physical environment 305, as similarly described herein, and as indicated by notice 314f. In response, the first electronic device 101a updates what the option 336 is selectable to perform, as shown from FIG. 39 to FIG. 40. For example, when the first user 301a was not collocated in the physical environment 305 with the second user 301b and the third user 301c, and while the first electronic device 101a was displaying the option 336 in FIG. 37, the option was selectable to perform a first operation (“Operation A”), and in response to detecting that the first user 301a is collocated in the physical environment 305 with the second user 301b and the third user 301c, the first electronic device 101a updated the operation the option 336 is selectable to perform. For example, when the first user 301a was not collocated in the physical environment 305 with the second user 301b and the third user 301c in FIG. 38, option 336 was optionally selectable to initiate a first type of multi-user communication session between the first user 301a, the second user 301b, and the third user 301c (e.g., a first type of communication session between the first electronic device 101a, the second electronic device 101b, and the third electronic device 101c, such as a multi-user communication session in which virtual avatars or other visual representations of one or more of the first user 301a, the second user 301b, or the third user 301c would be displayed). Continuing with this example, in response to detecting that the first user 301a is collocated in the physical environment 305 with the second user 301b and the third user 301c in FIG. 40, the first electronic device 101a updated the option 336 so that it would be selectable to initiate a second type of multi-user communication session between the first user 301a, the second user 301b, and the third user 301c that is different from the first type of multi-user communication session. For example, the second type of multi-user communications session is optionally a communication session in which virtual avatars representative of remote users of the multi-user communication session would optionally not be displayed since there would be no remote users since the users are collocated in the physical environment.

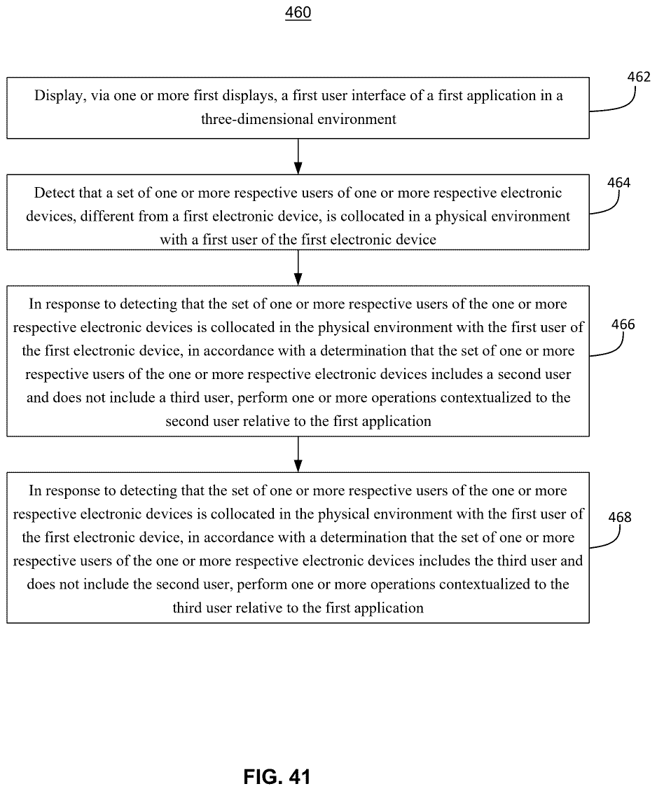

FIG. 41 illustrates a flow diagram illustrating a method 460 for performing one or more operations contextualized to a set of users of electronic devices that are collocated in a physical environment according to some examples of the disclosure. One or more examples of method 460 are illustrated and/or described above with reference to one or more of FIGS. 3 through 40. It is understood that method 460 is an example and that more, fewer, or different operations can be performed in the same or in a different order. Additionally, the operations in method 460 described below are, optionally, implemented by running one or more functional modules in an information processing apparatus such as general-purpose processors (e.g., as described with respect to FIGS. 2A through 2C) or application specific chips, and/or by other components described with respect to FIGS. 2A through 2C.

Therefore, according to the above, some examples of the disclosure are directed to a method (e.g., method 460 of FIG. 41). In some examples, the method 460 is performed at a first electronic device that is in communication with one or more first displays and one or more first input devices. In some examples, the first electronic device displays (462), via the one or more first displays, a first user interface of a first application in a three-dimensional environment, such as the user interface 312 of the music application in FIG. 8A. In some examples, the first electronic device detects (464) that a set of one or more respective users of one or more respective electronic devices, different from the first electronic device, is collocated in a physical environment with a first user of the first electronic device, such as the notice 314a in FIG. 5 that Alice is detected as being collocated in the physical environment with the first user 301a of the first electronic device 101a. In some examples, detecting that the set of one or more respective users of one or more respective electronic devices is collocated in the physical environment with the first user of the first electronic device includes detecting one or more respective electronic devices that are collocated with the first electronic device, and identifying the one or more respective users associated with those respective electronic devices (e.g., via account information, such as username information and/or other information that indicates the respective user(s) that is associated with the specific electronic device(s) that is collocated with the first electronic device in the physical environment) and/or includes detecting the set of one or more respective users in the physical environment, such as via visual identification of the one or more respective users using cameras (e.g., cameras (e.g., image capturing devices) of the first electronic device). In some examples, in response to detecting that the set of one or more respective users of the one or more respective electronic devices is collocated in the physical environment with the first user of the first electronic device, in accordance with a determination that the set of one or more respective users of the one or more respective electronic devices includes a second user and does not include a third user, the first electronic device performs (466) one or more operations contextualized to the second user relative to the first application, such as displaying of the suggestion element 316 in FIG. 6 in response to the detection of the collocation of the second user 301b with the first user 301a in the physical environment 305 in FIG. 5. In some examples, in response to detecting that the set of one or more respective users of the one or more respective electronic devices is collocated in the physical environment with the first user of the first electronic device, in accordance with a determination that the set of one or more respective users of the one or more respective electronic devices includes the third user and does not include the second user, the first electronic device (468) performs one or more operations contextualized to the third user relative to the first application (e.g., without performing the one or more operations contextualized to the second user relative to the first application), such as displaying the suggestion element 316 in FIG. 12 in response to the detection of the collocation of the third user 301c with the first user 301a in the physical environment 305 in FIG. 12.

Additionally or alternatively, in some examples, the first electronic device detects that no user is collocated in the physical environment with the first user of the first electronic device, and in response to detecting that no user is collocated in the physical environment with the first user of the first electronic device, the first electronic device performs one or more default operations relative to the first application, such as described with reference to FIG. 22.

Additionally or alternatively, in some examples, in response to detecting that the set of one or more respective users of the one or more respective electronic devices is collocated in the physical environment with the first user of the first electronic device, in accordance with a determination that the set of one or more respective users of the one or more respective electronic devices includes the second user and the third user, the first electronic device performs one or more operations contextualized to the second user and to the third user relative to the first application, such as described with reference to FIGS. 16 through 18.

Additionally or alternatively, in some examples, performing the one or more operations includes displaying, via the one or more first displays, one or more suggestions that are indicative of the set of one or more respective users of the one or more respective electronic devices such that, in accordance with the determination that the set of one or more respective users of the one or more respective electronic devices includes the second user and does not include the third user, displaying, via the one or more first displays, the one or more suggestions includes displaying one or more first suggestions without one or more second suggestions, such as the suggestion element 316 in FIG. 6, and in accordance with the determination that the set of one or more respective users of the one or more respective electronic devices includes the third user and does not include the second user, displaying, via the one or more first displays, the one or more suggestions includes displaying the one or more second suggestions without the one or more first suggestions, such as the suggestion element 316 in FIG. 12. Additionally or alternatively, in some examples, displaying the one or more first suggestions without the one or more second suggestions includes displaying, via the one or more first displays, the one or more first suggestions at a location that is based on a spatial arrangement between a viewpoint of the first electronic device and a location of the second user in the three-dimensional environment, such as described with reference to FIG. 6, and displaying the one or more second suggestions without the one or more first suggestions includes displaying, via the one or more first displays, the one or more second suggestions at a location that is based on a spatial arrangement between the viewpoint of the first electronic device and a location of the third user in the three-dimensional environment, such as described with reference to FIG. 12.

Additionally or alternatively, in some examples, the one or more first suggestions include a set of one or more user interface elements indicative of one or more previous interactions between the first user and the set of one or more respective users of the one or more respective electronic devices that includes the second user and does not include the third user, such as described with reference to FIG. 6, and the one or more second suggestions include a set of one or more user interface elements indicative of one or more previous interactions between the first user and the set of one or more respective users of the one or more respective electronic devices that includes the third user and does not include the second user, such as described with reference to FIG. 12.

Additionally or alternatively, in some examples, displaying, via the one or more first displays, the first user interface of the first application is performed in response to detecting that the set of one or more respective users of the one or more respective electronic devices is collocated in the physical environment with the first user of the first electronic device, such as described with reference to FIGS. 5 and 6. Additionally or alternatively, in some examples, in accordance with the determination that the set of one or more respective users of the one or more respective electronic devices includes the second user and does not include the third user, the first user interface of the first application is a first respective user interface of a first respective application, such as the user interface 312 of the music application in FIG. 8A. Additionally or alternatively, in some examples, in accordance with the determination that the set of one or more respective users of the one or more respective electronic devices includes the third user and does not include the second user, the first user interface of the first application is a second respective user interface of a second respective application that is different from the first respective user interface of the first respective application, such as the user interface 317 of the gaming application in FIG. 14.

Additionally or alternatively, in some examples, before displaying the first user interface of the first application, performing the one or more operations includes displaying, via the one or more first displays, a respective user interface element that is selectable to display the first user interface of the first application, such as the suggestion element 316 in FIG. 6. Additionally or alternatively, in some examples, in accordance with the determination that the set of one or more respective users of the one or more respective electronic devices includes the second user and does not include the third user, the first user interface of the first application that the respective user interface element is selectable to display is a first respective user interface of a first respective application, such as the suggestion element 316 in FIG. 6. Additionally or alternatively, in some examples, in accordance with the determination that the set of one or more respective users of the one or more respective electronic devices includes the third user and does not include the second user, the first user interface of the first application that the respective user interface element is selectable to display is a second respective user interface of a second respective application that is different from the first respective user interface of the first respective application, such as the suggestion element 316 in FIG. 12. Additionally or alternatively, in some examples, displaying the first user interface of the first application is performed in response to detecting, via the one or more first input devices, selection of the respective user interface element, such as the selection of option 316a in FIG. 13.

Additionally or alternatively, in some examples, the first respective application is an application previously interacted with by the first user and the set of one or more respective users of the one or more respective electronic devices that includes the second user and does not include the third user, and the second respective application is the application previously interacted with by the first user and the set of one or more respective users of the one or more respective electronic devices that includes the third user and does not include the second user.

Additionally or alternatively, in some examples, the first respective application that is the application previously interacted with by the first user and the set of one or more respective users of the one or more respective electronic devices that includes the second user and does not include the third user is an application previously interacted with by the first user and the set of one or more respective users of the one or more respective electronic devices that includes the second user and does not include the third user when the set of one or more respective users that includes the second user and does not include the third user was previously collocated in a respective physical environment with the first user, such as described with reference to FIG. 6. Additionally or alternatively, in some examples, the second respective application that is the application previously interacted with by the first user and the set of one or more respective users of the one or more respective electronic devices that includes the third user and does not include the second user is an application previously interacted with by the first user and the set of one or more respective users of the one or more respective electronic devices that includes the third user and does not include the second user when the set of one or more respective users that includes the third user and does not include the second user was previously collocated in the respective physical environment with the first user, such as described with reference to FIG. 12.

Additionally or alternatively, in some examples, detecting that the set of one or more respective users of the one or more respective electronic devices is collocated in the physical environment with the first user of the first electronic device comprises detecting a spatial arrangement of the set of one or more respective users of the one or more respective electronic devices that is collocated in the physical environment with the first user of the first electronic device. Additionally or alternatively, in some examples, performing the one or more operations is based on the spatial arrangement of the set of one or more respective users of the one or more respective electronic devices that is collocated in the physical environment with the first user of the first electronic device. For example, the location of display of the user interface 312 of the music application in FIG. 13 is optionally based on the location of the third user 301c. Additionally, the location of the display of the suggestion element 316 in FIG. 12 is optionally based on the location of the third user 301c.

Additionally or alternatively, in some examples, before performing the one or more operations (or before detecting that the set of one or more respective users of the one or more respective electronic devices is collocated in the physical environment with the first user of the first electronic device), displaying the first user interface of the first application includes displaying, via the one or more first displays, the first user interface without a first indication of the set of one or more respective users of the one or more respective electronic devices that is collocated in the physical environment with the first user of the first electronic device, such as the user interface 331 of the movie application in FIG. 36. Additionally or alternatively, in some examples, performing the one or more operations (e.g., in response to detecting that the set of one or more respective users of the one or more respective electronic devices is collocated in the physical environment with the first user of the first electronic device) includes displaying the first user interface of the first application with the first indication of the set of one or more respective users of the one or more respective electronic devices that is collocated in the physical environment with the first user of the first electronic device, such as the user interface 331 including the indication that the first user 301a is with the fifth user 301e of the fifth electronic device 101e in the physical environment 305 in FIG. 37.

Additionally or alternatively, in some examples, detecting that the set of one or more respective users of the one or more respective electronic devices is collocated in the physical environment with the first user of the first electronic device includes detecting one or more identifiers of the one or more respective users of the one or more respective electronic devices that indicate that the one or more respective users are logged into one or more user accounts associated with the one or more respective electronic devices, such as described with reference to FIG. 5.

Additionally or alternatively, in some examples, in response to detecting that the set of one or more respective users of the one or more respective electronic devices is collocated in the physical environment with the first user of the first electronic device, in accordance with the determination that the set of one or more respective users of the one or more respective electronic devices includes the second user and does not include the third user, the first electronic device visually emphasizes one or more locations of the one or more respective users of respective electronic devices of the set of one or more respective users of the one or more respective electronic devices that includes the second user and does not include the third user, including visually emphasizing, via the one or more first displays, a location of the second user, relative to a viewpoint of the first electronic device, such as described with reference to FIGS. 31 and 32. Additionally or alternatively, in some examples, in response to detecting that the set of one or more respective users of the one or more respective electronic devices is collocated in the physical environment with the first user of the first electronic device, in accordance with the determination that the set of one or more respective users of the one or more respective electronic devices includes the third user and does not include the second user, visually emphasizing one or more locations of the one or more respective users of respective electronic devices of the set of one or more respective users of the one or more respective electronic devices that includes the third user and does not include the second user, including visually emphasizing, via the one or more first displays, a location of the third user, relative to the viewpoint of the first electronic device, such as described with reference to FIGS. 31 and 32.

Additionally or alternatively, in some examples, detecting that the set of one or more respective users of the one or more respective electronic devices is collocated in the physical environment with the first user of the first electronic device is performed while displaying the first user interface of the first application, such as shown with the user interface 334 of the messaging application in FIGS. 38 through 40.

Additionally or alternatively, in some examples, detecting that the set of one or more respective users of the one or more respective electronic devices is collocated in the physical environment with the first user of the first electronic device is performed before displaying the first user interface of the first application, such as shown with detecting that the first user 301a is collocated with the second user 301b in FIG. 5 before displaying the suggestion element 316 in FIG. 6 (and/or before displaying the user interface 312 of the music application in FIG. 8A.

Some examples of the disclosure are directed to a first electronic device comprising one or more processors and memory, where the one or more processors are configured to execute one or more programs stored in the memory, and where the one or more programs include instructions for performing any of the above methods. Some examples of the disclosure are directed to a non-transitory computer readable storage medium storing one or more programs, where the one or more programs comprise instructions, which when executed by one or more processors of a first electronic device, cause the first electronic device to perform any of the above methods. Some examples of the disclosure are directed to a first electronic device that comprises one or more processors, memory, and means for performing any of the above methods. Some examples of the disclosure are directed to an information processing apparatus for use in a first electronic device, where the information processing apparatus comprises means for performing any of the above methods.

It is understood that the examples shown and described herein are merely exemplary and that additional and/or alternative elements may be provided for performing operations based on a presence of a set of users of electronic devices that are collocated in a physical environment. It should be understood that the appearance, shape, form, and size of each of the various user interface elements and objects shown and described herein are exemplary and that alternative appearances, shapes, forms and/or sizes may be provided. For example, the virtual objects representative of user interfaces may be provided in an alternative shape than a rectangular shape, such as a circular shape, triangular shape, etc. In some examples, the various selectable affordances described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

As described above, one aspect of the present technology is the gathering and use of data available from various sources to improve extended reality (XR) experiences of users. The present disclosure contemplates that in some instances, this gathered data may include personal information data that uniquely identifies or can be used to contact or locate a specific person. Such personal information data can include demographic data, location-based data, telephone numbers, email addresses, TWITTER IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

What is claimed is:

1. A method comprising:
at a first electronic device that is in communication with one or more first displays and one or more first input devices:
displaying, via the one or more first displays, a first user interface of a first application in a three-dimensional environment;
detecting that a set of one or more respective users of one or more respective electronic devices, different from the first electronic device, is collocated in a physical environment with a first user of the first electronic device; and
in response to detecting that the set of one or more respective users of the one or more respective electronic devices is collocated in the physical environment with the first user of the first electronic device:
in accordance with a determination that the set of one or more respective users of the one or more respective electronic devices includes a second user and does not include a third user, performing one or more operations contextualized to the second user relative to the first application; and
in accordance with a determination that the set of one or more respective users of the one or more respective electronic devices includes the third user and does not include the second user, performing one or more operations contextualized to the third user relative to the first application.

2. The method of claim 1, comprising:
detecting that no user is collocated in the physical environment with the first user of the first electronic device; and
in response to detecting that no user is collocated in the physical environment with the first user of the first electronic device, performing one or more default operations relative to the first application.

3. The method of claim 1, comprising in response to detecting that the set of one or more respective users of the one or more respective electronic devices is collocated in the physical environment with the first user of the first electronic device, in accordance with a determination that the set of one or more respective users of the one or more respective electronic devices includes the second user and the third user, performing one or more operations contextualized to the second user and to the third user relative to the first application.

4. The method of claim 1, wherein performing the one or more operations includes displaying, via the one or more first displays, one or more suggestions that are indicative of the set of one or more respective users of the one or more respective electronic devices such that:
in accordance with the determination that the set of one or more respective users of the one or more respective electronic devices includes the second user and does not include the third user, displaying, via the one or more first displays, the one or more suggestions includes displaying one or more first suggestions without one or more second suggestions; and
in accordance with the determination that the set of one or more respective users of the one or more respective electronic devices includes the third user and does not include the second user, displaying, via the one or more first displays, the one or more suggestions includes displaying the one or more second suggestions without the one or more first suggestions.

5. The method of claim 4, wherein:
the one or more first suggestions include a set of one or more user interface elements indicative of one or more previous interactions between the first user and the set of one or more respective users of the one or more respective electronic devices that includes the second user and does not include the third user; and
the one or more second suggestions include a set of one or more user interface elements indicative of one or more previous interactions between the first user and the set of one or more respective users of the one or more respective electronic devices that includes the third user and does not include the second user.

6. The method of claim 1, wherein:
displaying, via the one or more first displays, the first user interface of the first application is performed in response to detecting that the set of one or more respective users of the one or more respective electronic devices is collocated in the physical environment with the first user of the first electronic device;
in accordance with the determination that the set of one or more respective users of the one or more respective electronic devices includes the second user and does not include the third user, the first user interface of the first application is a first respective user interface of a first respective application; and
in accordance with the determination that the set of one or more respective users of the one or more respective electronic devices includes the third user and does not include the second user, the first user interface of the first application is a second respective user interface of a second respective application that is different from the first respective user interface of the first respective application.

7. The method of claim 6, wherein:
the first respective application is an application previously interacted with by the first user and the set of one or more respective users of the one or more respective electronic devices that includes the second user and does not include the third user; and
the second respective application is the application previously interacted with by the first user and the set of one or more respective users of the one or more respective electronic devices that includes the third user and does not include the second user.

8. The method of claim 7, wherein:
the first respective application that is the application previously interacted with by the first user and the set of one or more respective users of the one or more respective electronic devices that includes the second user and does not include the third user is an application previously interacted with by the first user and the set of one or more respective users of the one or more respective electronic devices that includes the second user and does not include the third user when the set of one or more respective users that includes the second user and does not include the third user was previously collocated with the first user in a respective physical environment; and
the second respective application that is the application previously interacted with by the first user and the set of one or more respective users of the one or more respective electronic devices that includes the third user and does not include the second user is an application previously interacted with by the first user and the set of one or more respective users of the one or more respective electronic devices that includes the third user and does not include the second user when the set of one or more respective users that includes the third user and does not include the second user was previously collocated with the first user in the respective physical environment.

9. A first electronic device comprising:
one or more processors; and
memory, wherein the first electronic device is in communication with one or more first displays and one or more first input devices, wherein the one or more processors are configured to execute one or more programs stored in the memory, and wherein the one or more programs include instructions for performing a method comprising:
displaying, via the one or more first displays, a first user interface of a first application in a three-dimensional environment;
detecting that a set of one or more respective users of one or more respective electronic devices, different from the first electronic device, is collocated in a physical environment with a first user of the first electronic device; and
in response to detecting that the set of one or more respective users of the one or more respective electronic devices is collocated in the physical environment with the first user of the first electronic device:
in accordance with a determination that the set of one or more respective users of the one or more respective electronic devices includes a second user and does not include a third user, performing one or more operations contextualized to the second user relative to the first application; and
in accordance with a determination that the set of one or more respective users of the one or more respective electronic devices includes the third user and does not include the second user, performing one or more operations contextualized to the third user relative to the first application.

10. The first electronic device of claim 9, wherein:
before displaying the first user interface of the first application, performing the one or more operations includes displaying, via the one or more first displays, a respective user interface element that is selectable to display the first user interface of the first application;
in accordance with the determination that the set of one or more respective users of the one or more respective electronic devices includes the second user and does not include the third user, the first user interface of the first application that the respective user interface element is selectable to display is a first respective user interface of a first respective application;
in accordance with the determination that the set of one or more respective users of the one or more respective electronic devices includes the third user and does not include the second user, the first user interface of the first application that the respective user interface element is selectable to display is a second respective user interface of a second respective application that is different from the first respective user interface of the first respective application; and
displaying the first user interface of the first application is performed in response to detecting, via the one or more first input devices, selection of the respective user interface element.

11. The first electronic device of claim 9, wherein:
detecting that the set of one or more respective users of the one or more respective electronic devices is collocated in the physical environment with the first user of the first electronic device comprises detecting a spatial arrangement of the set of one or more respective users of the one or more respective electronic devices that is collocated in the physical environment with the first user of the first electronic device; and
performing the one or more operations is based on the spatial arrangement of the set of one or more respective users of the one or more respective electronic devices that is collocated in the physical environment with the first user of the first electronic device.

12. The first electronic device of claim 9, wherein:
before detecting that the set of one or more respective users of the one or more respective electronic devices is collocated in the physical environment with the first user of the first electronic device, displaying the first user interface of the first application includes displaying, via the one or more first displays, the first user interface without a first indication of the set of one or more respective users of the one or more respective electronic devices that is collocated in the physical environment with the first user of the first electronic device; and
performing the one or more operations in response to detecting that the set of one or more respective users of the one or more respective electronic devices is collocated in the physical environment with the first user of the first electronic device includes displaying the first user interface of the first application with the first indication of the set of one or more respective users of the one or more respective electronic devices that is collocated in the physical environment with the first user of the first electronic device.

13. The first electronic device of claim 9, wherein detecting that the set of one or more respective users of the one or more respective electronic devices is collocated in the physical environment with the first user of the first electronic device includes detecting one or more identifiers of the one or more respective users of the one or more respective electronic devices that indicate that the one or more respective users are logged into one or more user accounts associated with the one or more respective electronic devices.

14. The first electronic device of claim 9, wherein the method comprises:
in response to detecting that the set of one or more respective users of the one or more respective electronic devices is collocated in the physical environment with the first user of the first electronic device:
in accordance with the determination that the set of one or more respective users of the one or more respective electronic devices includes the second user and does not include the third user, visually emphasizing one or more locations of the one or more respective users of respective electronic devices of the set of one or more respective users of the one or more respective electronic devices that includes the second user and does not include the third user, including visually emphasizing, via the one or more first displays, a location of the second user, relative to a viewpoint of the first electronic device; and
in accordance with the determination that the set of one or more respective users of the one or more respective electronic devices includes the third user and does not include the second user, visually emphasizing one or more locations of the one or more respective users of respective electronic devices of the set of one or more respective users of the one or more respective electronic devices that includes the third user and does not include the second user, including visually emphasizing, via the one or more first displays, a location of the third user, relative to the viewpoint of the first electronic device.

15. The first electronic device of claim 9, wherein detecting that the set of one or more respective users of the one or more respective electronic devices is collocated in the physical environment with the first user of the first electronic device is performed while displaying the first user interface of the first application.

16. The first electronic device of claim 9, wherein detecting that the set of one or more respective users of the one or more respective electronic devices is collocated in the physical environment with the first user of the first electronic device is performed before displaying the first user interface of the first application.

17. A non-transitory computer readable storage medium storing one or more programs, the one or more programs comprising instructions, which when executed by one or more processors of a first electronic device that is in communication with one or more first displays and one or more first input devices, cause the first electronic device to perform a method comprising:
displaying, via the one or more first displays, a first user interface of a first application in a three-dimensional environment;
detecting that a set of one or more respective users of one or more respective electronic devices, different from the first electronic device, is collocated in a physical environment with a first user of the first electronic device; and
in response to detecting that the set of one or more respective users of the one or more respective electronic devices is collocated in the physical environment with the first user of the first electronic device:
in accordance with a determination that the set of one or more respective users of the one or more respective electronic devices includes a second user and does not include a third user, performing one or more operations contextualized to the second user relative to the first application; and
in accordance with a determination that the set of one or more respective users of the one or more respective electronic devices includes the third user and does not include the second user, performing one or more operations contextualized to the third user relative to the first application.

18. The non-transitory computer readable storage medium of claim 17, wherein the method comprises:
detecting that no user is collocated in the physical environment with the first user of the first electronic device; and
in response to detecting that no user is collocated in the physical environment with the first user of the first electronic device, performing one or more default operations relative to the first application.

19. The non-transitory computer readable storage medium of claim 17, wherein the method comprises in response to detecting that the set of one or more respective users of the one or more respective electronic devices is collocated in the physical environment with the first user of the first electronic device, in accordance with a determination that the set of one or more respective users of the one or more respective electronic devices includes the second user and the third user, performing one or more operations contextualized to the second user and to the third user relative to the first application.

20. The non-transitory computer readable storage medium of claim 17, wherein performing the one or more operations includes displaying, via the one or more first displays, one or more suggestions that are indicative of the set of one or more respective users of the one or more respective electronic devices such that:
in accordance with the determination that the set of one or more respective users of the one or more respective electronic devices includes the second user and does not include the third user, displaying, via the one or more first displays, the one or more suggestions includes displaying one or more first suggestions without one or more second suggestions; and
in accordance with the determination that the set of one or more respective users of the one or more respective electronic devices includes the third user and does not include the second user, displaying, via the one or more first displays, the one or more suggestions includes displaying the one or more second suggestions without the one or more first suggestions.

21. The non-transitory computer readable storage medium of claim 20, wherein:
the one or more first suggestions include a set of one or more user interface elements indicative of one or more previous interactions between the first user and the set of one or more respective users of the one or more respective electronic devices that includes the second user and does not include the third user; and
the one or more second suggestions include a set of one or more user interface elements indicative of one or more previous interactions between the first user and the set of one or more respective users of the one or more respective electronic devices that includes the third user and does not include the second user.

22. The non-transitory computer readable storage medium of claim 17, wherein:
displaying, via the one or more first displays, the first user interface of the first application is performed in response to detecting that the set of one or more respective users of the one or more respective electronic devices is collocated in the physical environment with the first user of the first electronic device;
in accordance with the determination that the set of one or more respective users of the one or more respective electronic devices includes the second user and does not include the third user, the first user interface of the first application is a first respective user interface of a first respective application; and
in accordance with the determination that the set of one or more respective users of the one or more respective electronic devices includes the third user and does not include the second user, the first user interface of the first application is a second respective user interface of a second respective application that is different from the first respective user interface of the first respective application.

23. The non-transitory computer readable storage medium of claim 22, wherein:
the first respective application is an application previously interacted with by the first user and the set of one or more respective users of the one or more respective electronic devices that includes the second user and does not include the third user; and
the second respective application is the application previously interacted with by the first user and the set of one or more respective users of the one or more respective electronic devices that includes the third user and does not include the second user.

24. The non-transitory computer readable storage medium of claim 23, wherein:
the first respective application that is the application previously interacted with by the first user and the set of one or more respective users of the one or more respective electronic devices that includes the second user and does not include the third user is an application previously interacted with by the first user and the set of one or more respective users of the one or more respective electronic devices that includes the second user and does not include the third user when the set of one or more respective users that includes the second user and does not include the third user was previously collocated with the first user in a respective physical environment; and
the second respective application that is the application previously interacted with by the first user and the set of one or more respective users of the one or more respective electronic devices that includes the third user and does not include the second user is an application previously interacted with by the first user and the set of one or more respective users of the one or more respective electronic devices that includes the third user and does not include the second user when the set of one or more respective users that includes the third user and does not include the second user was previously collocated with the first user in the respective physical environment.
